(19) United States
(12) Patent Application Publication
(10) Pub. No.: US 2012/0195513 A1
(43) Pub. Date: Aug. 2, 2012

(54) IMAGE PROCESSING DEVICE AND IMAGE PROCESSING METHOD

(75) Inventors: Teruhiko Suzuki, Kanagawa (JP); Yoshitomo Takahashi, Kanagawa (JP); Takuya Kitamura, Tokyo (JP)

(73) Assignee: Sony Corporation, Tokyo (JP)

(21) Appl. No.: 13/500,374

(22) PCT Filed: Oct. 8, 2010
(86) PCT No.: PCT/JP2010/067757

§ 371 Date: Apr. 5, 2012

(30) Foreign Application Priority Data
Oct. 16, 2009 (JP) 2009-239707

(51) Int. Cl. G06K 9/36

(52) U.S. Cl. 382/233; 382/232

(57) ABSTRACT

The present invention relates to an image processing device and an image processing method that enable a set of images of multiple visual points which images form a stereoscopic image to be recognized in a case of multiplexing and coding the images of the multiple visual points which images form the stereoscopic image even when the coded data is decoded from the middle in a decoding device.

A coding system performs coding such that a picture of a random access point is a picture of an L-image of an LR pair and a picture of an R-image is a picture subsequent to the picture of the random access point in coding order. The present invention is applicable to devices for coding stereoscopic images, for example.

### TECHNICAL FIELD

The present invention relates to an image processing device and an image processing method, and particularly to an image processing device and an image processing method that enable a set of images of multiple visual points which images form a stereoscopic image to be recognized in a case of multiplexing and coding the images of the multiple visual points which images form the stereoscopic image even when the coded data is decoded from the middle in a decoding device.

### BACKGROUND ART

Recently, devices conforming to a system such as MPEG (Moving Picture Experts Group) or the like, which devices treat image information as a digital signal and which, in doing so, compress the image information by an orthogonal transform such as a discrete cosine transform or the like and motion compensation using redundancy unique to the image information with an objective of highly efficient transmission and storage of the information, have been spreading both in information distribution by broadcasting stations and the like and in information reception in ordinary households.

Specifically, coding devices and decoding devices have been spreading which devices are used to receive image information (bit stream) compressed by a coding system using an orthogonal transform such as a discrete cosine transform, a Karhunen-Loeve transform, or the like and motion compensation, such for example as MPEG, H.26x, or the like, via network media such as satellite broadcasting, cable TV, the Internet, and the like or to process the image information on storage media such as optical, magnetic disks, and flash memories.

For example, MPEG2 (ISO/IEC 13818-2) is defined as a general-purpose image coding system. MPEG2 is a standard covering both of interlaced scanning images (images of an interlacing system) and progressive scanning images (images of a progressive system) as well as standard-resolution images and high-definition images. MPEG2 is now used widely for a wide range of applications in professional uses and consumer uses. When the MPEG2 compression system is used, a high compression rate and excellent image quality can be achieved by assigning a code amount (bit rate) of 4 to 8 Mbps to a standard-resolution interlaced scanning image having 720 horizontal pixels by 480 vertical pixels, for example, and assigning a code amount of 18 to 22 Mbps to a high-resolution interlaced scanning image having 1920 horizontal pixels by 1088 vertical pixels, for example.

While MPEG2 is mainly intended for high-image-quality coding suitable for broadcasting, no provision was made for a coding system offering a smaller code amount (bit rate), that is, a higher compression rate than MPEG1. A need for such a coding system is expected to increase in the future due to the spread of portable terminals, and an MPEG4 coding system was standardized in response to the need. As for an image coding system, a standard ISO/IEC 14496-2 was approved as an international standard in December 1998.

Further, the standardization of an AVC (MPEG-4 part 10, ISO/IEC 14496-10, ITU-T H.246) coding system is under way. A group referred to as a JVT (Joint Video Team) for standardizing an image coding system jointly between the ITU-T and the ISO/IEC is proceeding with this standardization.

AVC is a hybrid coding system including motion compensation and a discrete cosine transform, as with MPEG2 and MPEG4. It is known that while AVC requires a larger amount of calculation for coding and decoding than the conventional coding systems such as MPEG2 and MPEG4, AVC achieves higher coding efficiency.

Because imaging technology and display technology for stereoscopic images that can be viewed stereoscopically have recently made progress, not only contents of two-dimensional images but also contents of stereoscopic images are considered as contents of images as objects for coding as described above. Methods of coding and decoding images of multiple visual points are described in Patent Document 1, for example.

Stereoscopic images of a smallest number of visual points are 3D (Dimensional) images (stereo images) of two visual points. The image data of a 3D image includes the image data of a left eye image (hereinafter referred to also as an L (Left) image) as an image observed by a left eye and the image data of a right eye image (hereinafter referred to also as an R (Right) image) as an image observed by a right eye. Incidentally, description in the following will be made using 3D images of two visual points, which are the smallest number of visual points, as an example of images of multiple visual points which images form stereoscopic images, in order to simplify the description.

As shown in FIG. 1, when the coded data of a 3D image is a bit stream obtained as a result of multiplexing and coding L-images and R-images (hereinafter referred to as LR pairs) forming a 3D image in a temporal direction, a decoding device cannot recognize images whose coded data constitutes the coded data of an LR pair in a bit stream. Accordingly, the decoding device recognizes each set of two decoded images from a beginning in display order as an LR pair.

In this case, as shown in A of FIG. 2, the decoding device can recognize all of the LR pairs when no error occurs during the decoding of the bit stream.

### PRIOR ART DOCUMENT

### Patent Document

Patent Document 1: Japanese Patent Laid-Open No. 2008-182669

### SUMMARY OF THE INVENTION

### Technical Problem

However, as shown in B of FIG. 2, when an error occurs during the decoding of the bit stream, the decoding device cannot recognize LR pairs in subsequent decoded images. For example, in an example of B of FIG. 2, when a decoded image of an R-image as a fourth image from the beginning in display order is missing due to an error, LR pairs cannot be recognized in decoded images subsequent to the R-image. As a result, the stereoscopic image cannot be displayed once a decoding error has occurred.

In addition, when performing random access, the decoding device cannot recognize LR pairs in decoded images, and therefore may not be able to display the stereoscopic image from an arbitrary position.

The present invention has been made in view of such a situation. The present invention is to enable a set of images of multiple visual points which images form a stereoscopic image to be recognized in a case of multiplexing and coding the images of the multiple visual points which images form the stereoscopic image even when the coded data is decoded from the middle in a decoding device.

### Technical Solution

An image processing device according to a first aspect of the present invention includes: coding means for coding images of multiple visual points, the images of the multiple visual points forming a stereoscopic image; and controlling means for controlling the coding means so as to perform arrangement and coding such that a first picture in a random access unit is a picture of one image of the images of the multiple visual points and a picture of a remaining image is a picture subsequent to the first picture in coding order.

An image processing method according to the first aspect of the present invention corresponds to the image processing device according to the first aspect of the present invention.

In the first aspect of the present invention, images of multiple visual points which images form a stereoscopic image are coded. This coding is controlled so as to perform arrangement and the coding such that a first picture in a random access unit is a picture of one image of the images of the multiple visual points and a picture of a remaining image is a picture subsequent to the first picture in coding order.

An image processing device according to a second aspect of the present invention includes: decoding means for decoding a coded stream obtained by performing arrangement and coding such that a first picture in a random access unit of images of multiple visual points, the images of the multiple visual points forming a stereoscopic image, is a picture of one image of the images of the multiple visual points and a picture of a remaining image is a picture subsequent to the first picture in coding order; and controlling means for controlling the decoding means so as to start decoding from the first picture in the random access unit when the decoding means decodes the coded stream from a middle.

An image processing method according to the second aspect of the present invention corresponds to the image processing device according to the second aspect of the present invention.

In the second aspect of the present invention, a coded stream is decoded which coded stream is obtained by performing arrangement and coding such that a first picture in a random access unit of images of multiple visual points, the images of the multiple visual points forming a stereoscopic image, is a picture of one image of the images of the multiple visual points and a picture of a remaining image is a picture subsequent to the first picture in coding order. Incidentally, when the coded stream is decoded from the middle, the decoding is controlled so as to start the decoding from the first picture in the random access unit.

Incidentally, the image processing devices according to the first and second aspects may be an independent device, or may be an internal block forming one device.

In addition, the image processing devices according to the first and second aspects can be realized by making a computer execute a program.

### Advantageous Effects

According to the first aspect of the present invention, it is possible to recognize a set of images of multiple visual points which images form a stereoscopic image in a case of multiplexing and coding the images of the multiple visual points which images form the stereoscopic image even when the coded data is decoded from the middle in a decoding device.

According to the second aspect of the present invention, it is possible to recognize a set of images of multiple visual points which images form a stereoscopic image in a case of multiplexing and coding the images of the multiple visual points which images form the stereoscopic image even when the coded data is decoded from the middle.

### BRIEF DESCRIPTION OF DRAWINGS

FIG. 1 is a diagram of assistance in explaining the multiplexing of image signals of a 3D image.

FIG. 2 is a diagram of assistance in explaining a state in which an error has occurred during decoding.

FIG. 3 is a block diagram showing an example of configuration of one embodiment of a coding system to which the present invention is applied.

FIG. 4 is a block diagram showing an example of configuration of a video coding device in FIG. 1.

FIG. 5 is a diagram of assistance in explaining imaging timing in the coding system.

FIG. 6 is a diagram of assistance in explaining other imaging timing in the coding system.

FIG. 7 is a diagram of assistance in explaining multiplexing by a video synthesizing circuit.

FIG. 8 is a block diagram showing an example of configuration of a coding circuit in FIG. 4.

FIG. 9 is a diagram of assistance in explaining an example of a bit stream output from the coding circuit.

FIG. 10 is a diagram showing an example of the GOP structure of a bit stream.

FIG. 11 is a diagram showing another example of the GOP structure of a bit stream.

FIG. 12 is a diagram showing yet another example of the GOP structure of a bit stream.

FIG. 13 is a diagram showing yet another example of the GOP structure of a bit stream.

FIG. 14 is a flowchart of assistance in explaining a coding process by the coding circuit.

FIG. 15 is a block diagram showing another example of configuration of one embodiment of the coding system to which the present invention is applied.

FIG. 16 is a diagram of assistance in explaining a multiplexed signal output from a synthesizing section in FIG. 15.

FIG. 17 is a block diagram showing an example of configuration of a decoding system.

FIG. 18 is a block diagram showing an example of configuration of a video decoding device in FIG. 17.

FIG. 19 is a block diagram showing an example of configuration of a decoding circuit in FIG. 18.

FIG. 20 is a flowchart of assistance in explaining a decoding error process by the video decoding device.

FIG. 21 is a block diagram showing an example of configuration of one embodiment of a computer.

FIG. 22 is a block diagram showing an example of a main configuration of a television receiver to which the present invention is applied.

FIG. 23 is a block diagram showing an example of a main configuration of a portable telephone to which the present invention is applied.

FIG. 24 is a block diagram showing an example of a main configuration of a hard disk recorder to which the present invention is applied.

FIG. 25 is a block diagram showing an example of a main configuration of a camera to which the present invention is applied.

### MODE FOR CARRYING OUT THE INVENTION

### One Embodiment

### [Example of Configuration of One Embodiment of Coding System]

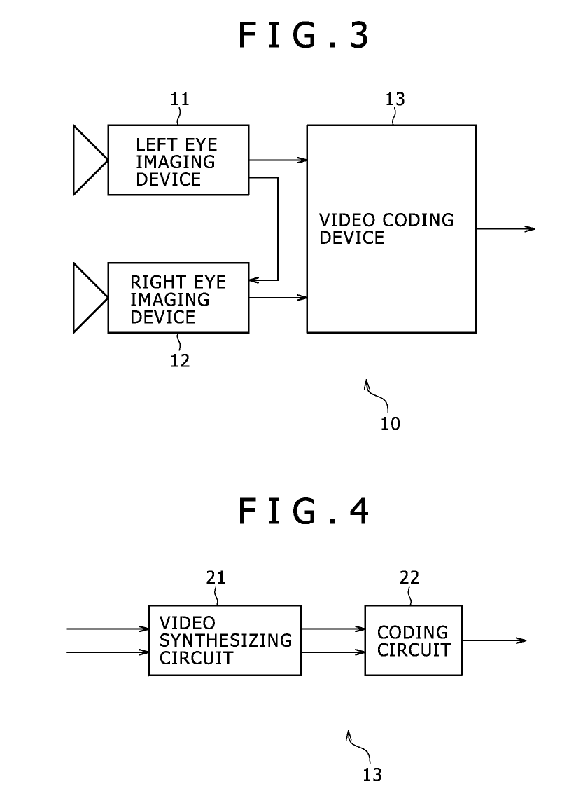

FIG. 3 is a block diagram showing an example of configuration of one embodiment of a coding system to which the present invention is applied.

A coding system 10 of FIG. 3 includes a left eye imaging device 11, a right eye imaging device 12, and a video coding device 13.

The left eye imaging device 11 is an imaging device for imaging an L-image. The right eye imaging device 12 is an imaging device for imaging an R-image. A synchronizing signal is input from the left eye imaging device 11 to the right eye imaging device 12, so that the left eye imaging device 11 and the right eye imaging device 12 are synchronized with each other. The left eye imaging device 11 and the right eye imaging device 12 perform imaging in predetermined imaging timing.

The video coding device 13 is supplied with the image signal of the L-image imaged by the left eye imaging device 11, and is supplied with the image signal of the R-image imaged by the right eye imaging device 12. The video coding device 13 multiplexes the image signal of the L-image and the image signal of the R-image in each LR pair in a temporal direction, and codes a multiplexed signal obtained as a result of the multiplexing in conformity to an AVC coding system. The video coding device 13 outputs coded data obtained as a result of the coding as a bit stream.

### [Example of Configuration of Video Coding Device]

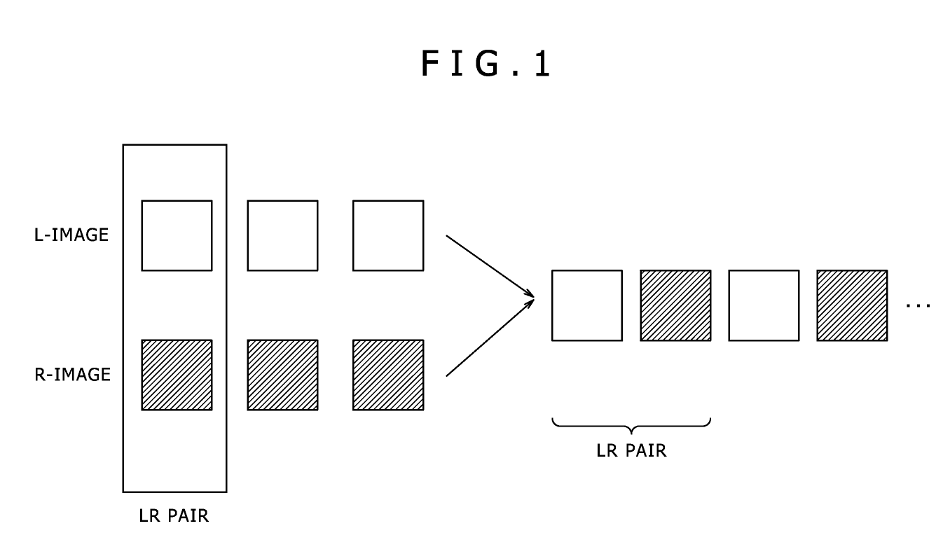

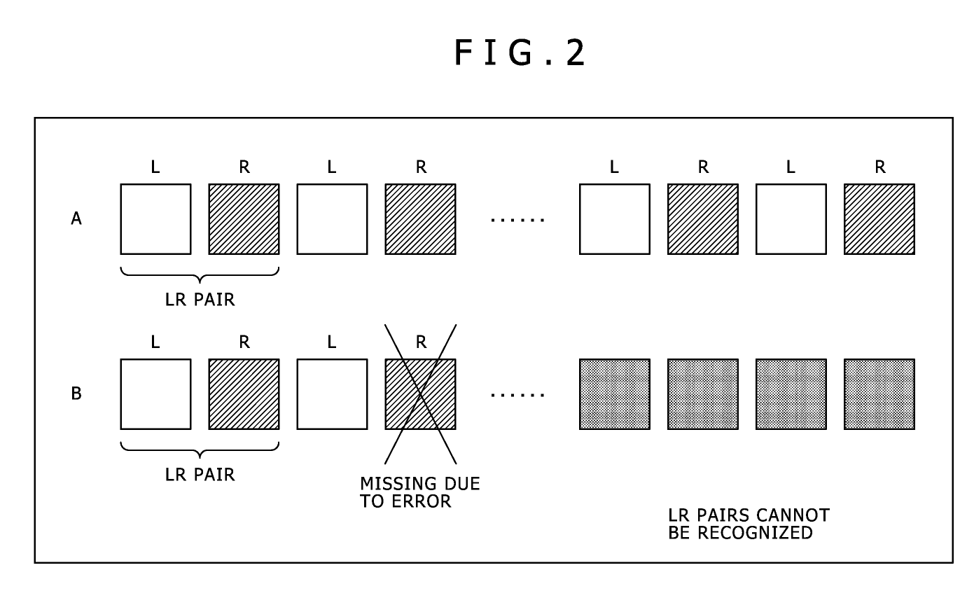

FIG. 4 is a block diagram showing an example of configuration of the video coding device 13 in FIG. 1.

The video coding device 13 of FIG. 4 includes a video synthesizing circuit 21 and a coding circuit 22.

The video synthesizing circuit 21 multiplexes the image signal of the L-image imaged by the left eye imaging device 11 and the image signal of the R-image imaged by the right eye imaging device 12 in each LR pair in a temporal direction, and supplies a multiplexed signal obtained as a result of the multiplexing to the coding circuit 22.

The coding circuit 22 codes the multiplexed signal input from the video synthesizing circuit 21 in conformity to the AVC coding system. Incidentally, at this time, the coding circuit 22 performs coding such that the display order of LR pairs continues in predetermined order and such that a first picture of a GOP (Group of Pictures) of coded data as a beginning of a random access unit (which beginning will hereinafter be referred to as a random access point) is one picture of an LR pair and another picture of the LR pair is a picture subsequent to the random access point in coding order. The coding circuit 22 outputs coded data obtained as a result of the coding as a bit stream.

Incidentally, description in the following will be made supposing that the coding circuit 22 performs coding such that the picture of a random access point is a picture of an L-image.

### [Description of Imaging Timing]

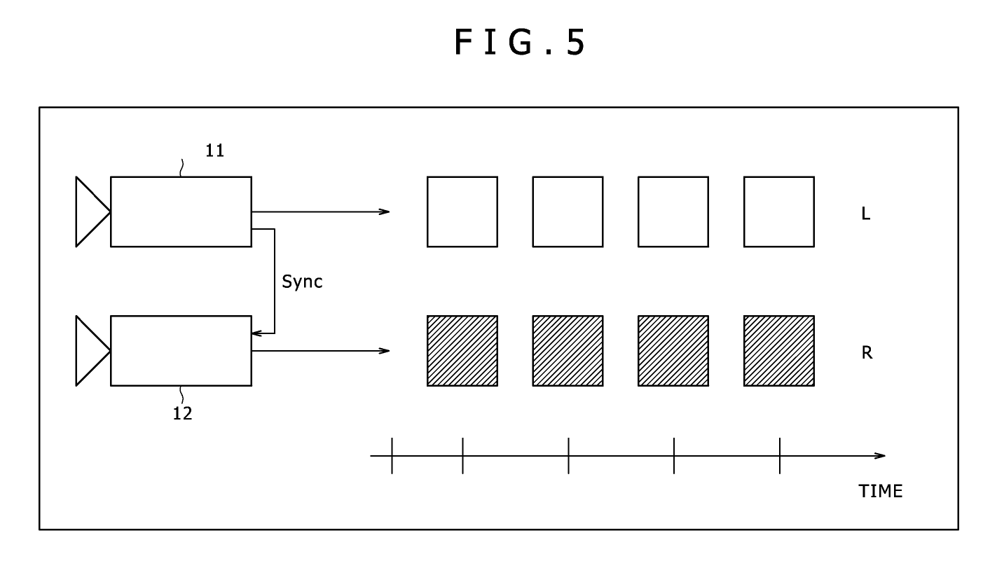

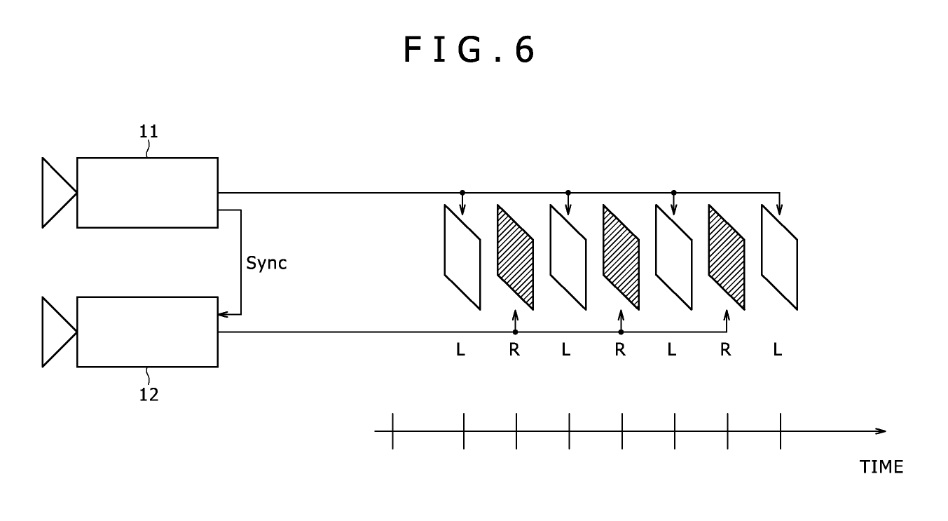

FIG. 5 and FIG. 6 are diagrams of assistance in explaining imaging timing in the coding system 10.

In the coding system 10, the left eye imaging device 11 and the right eye imaging device 12 image LR pairs in same timing as shown in FIG. 5, or image LR pairs in consecutive different timing as shown in FIG. 6.

### [Description of Multiplexing of L-Image and R-Image]

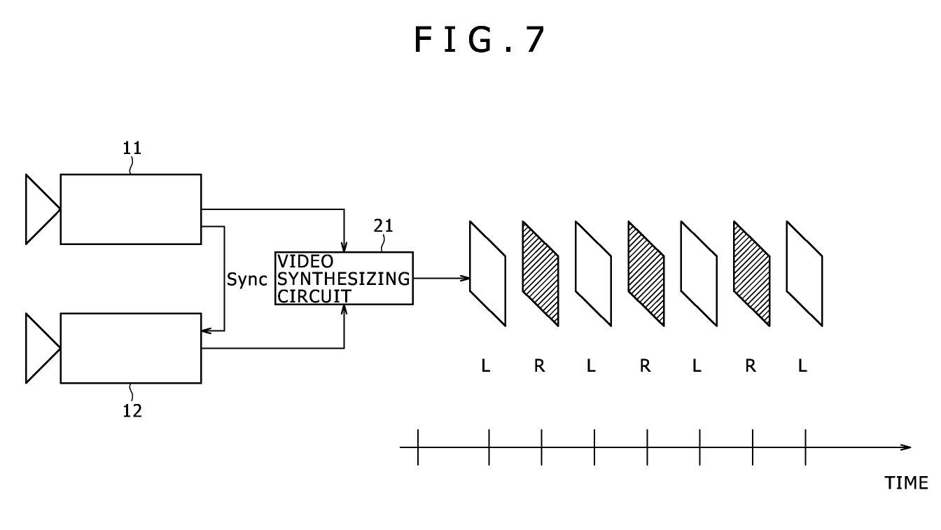

FIG. 7 is a diagram of assistance in explaining multiplexing by the video synthesizing circuit 21.

The image signal of the L-image and the image signal of the R-image imaged in the timing described with reference to FIG. 5 or FIG. 6 are supplied to the video synthesizing circuit 21 in parallel with each other. The video synthesizing circuit 21 multiplexes the image signal of the L-image and the image signal of the R-image of LR pairs in a temporal direction. Thus, the multiplexed signal output from the video synthesizing circuit 21 is an image signal in which the image signal of the L-image and the image signal of the R-image are alternately repeated, as shown in FIG. 7.

### [Example of Configuration of Coding Circuit]

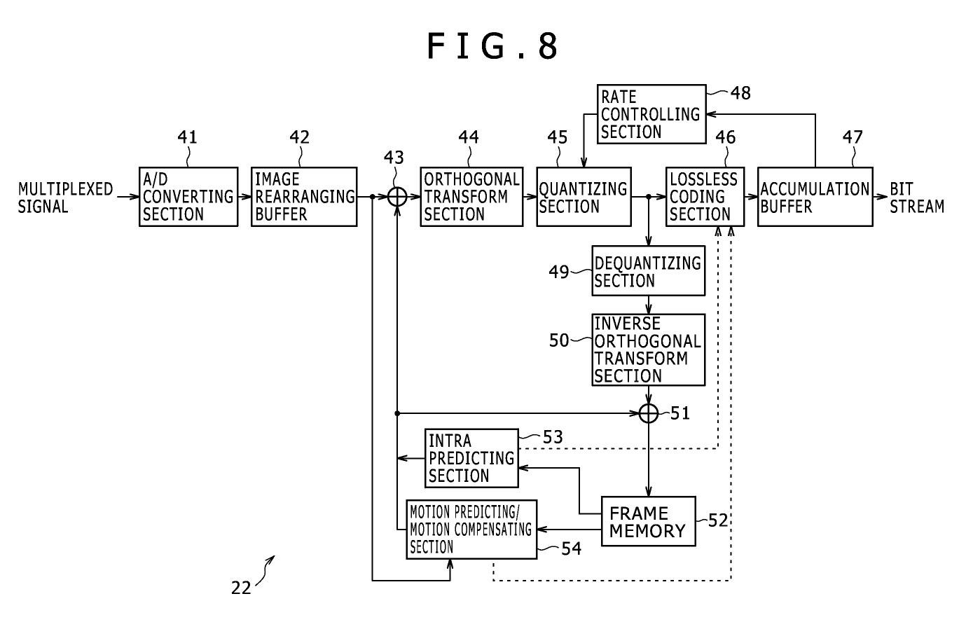

FIG. 8 is a block diagram showing an example of configuration of the coding circuit 22 in FIG. 4.

An A/D converting section 41 in the coding circuit 22 applies A/D conversion to the multiplexed signal as an analog signal supplied from the video synthesizing circuit 21, and thereby obtains image data as a digital signal. The A/D converting section 41 then supplies the image data to an image rearranging buffer 42.

The image rearranging buffer 42 temporarily stores the image data from the A/D converting section 41, and reads the image data as required. Thus, the image rearranging buffer 42 performs rearrangement that rearranges pictures (frames) (fields) of the image data in coding order so that the display order of LR pairs continues in predetermined order and so that the picture of a random access point is the picture of an L-image and the picture of an R-image forming an LR pair with the L-image is a picture subsequent to the random access point in the coding order, according to the GOP structure of the bit stream as the output of the coding circuit 22. That is, the image rearranging buffer 42 selects and controls pictures to be coded.

An intra picture to be subjected to intra coding among the pictures read from the image rearranging buffer 42 is supplied to an arithmetic section 43.

The arithmetic section 43 subtracts the pixel values of a predicted image supplied from an intra predicting section 53 from the pixel values of the intra picture supplied from the image rearranging buffer 42 as required, and supplies a result of the subtraction to an orthogonal transform section 44.

The orthogonal transform section 44 applies an orthogonal transform such as a discrete cosine transform, a Karhunen-Loeve transform, or the like to the intra picture (the pixel values of the intra picture or subtraction values obtained by subtracting the predicted image), and supplies transform coefficients obtained as a result of the orthogonal transform to a quantizing section 45. Incidentally, the discrete cosine transform performed in the orthogonal transform section 44 may be an integer transform approximating a real-number discrete cosine transform. In addition, a method of performing an integral coefficient transform in a 4×4 block size may be used as a transform method of the discrete cosine transform.

The quantizing section 45 quantizes the transform coefficients from the orthogonal transform section 44, and supplies quantized values obtained as result of the quantization to a lossless coding section 46.

The lossless coding section 46 applies lossless coding such as variable length coding, arithmetic coding, or the like to the quantized values from the quantizing section 45, and supplies coded data obtained as a result of the lossless coding to an accumulation buffer 47.

The accumulation buffer 47 temporarily stores the coded data from the lossless coding section 46, and outputs the coded data as a bit stream at a predetermined rate.

A rate controlling section 48 monitors an amount of accumulation of the coded data in the accumulation buffer 47. The rate controlling section 48 controls the behavior of the quantizing section 45 such as a quantization step and the like of the quantizing section 45 on the basis of the amount of accumulation.

The quantized values obtained in the quantizing section 45 are supplied not only to the lossless coding section 46 but also to a dequantizing section 49. The dequantizing section 49 dequantizes the quantized values from the quantizing section 45 into transform coefficients, and supplies the transform coefficients to an inverse orthogonal transform section 50.

The inverse orthogonal transform section 50 subjects the transform coefficients from the dequantizing section 49 to an inverse orthogonal transform, and supplies the result to an arithmetic section 51.

The arithmetic section 51 obtains a decoded image of the intra picture by adding the pixel values of the predicted image supplied from the intra predicting section 53 to the data supplied from the inverse orthogonal transform section 50 as required. The arithmetic section 51 supplies the decoded image to a frame memory 52.

The frame memory 52 temporarily stores the decoded image supplied from the arithmetic section 51, and supplies the decoded image to the intra predicting section 53 and a motion predicting/motion compensating section 54 as a reference image used to generate a predicted image as required.

The intra predicting section 53 generates a predicted image from pixels already stored in the frame memory 52 among pixels in the vicinity of a part (block) being processed in the arithmetic section 43 in the intra picture. The intra predicting section 53 supplies the predicted image to the arithmetic sections 43 and 51.

When a predicted image is supplied from the intra predicting section 53 to the arithmetic section 43 for a picture to be subjected to intra coding as described above, the arithmetic section 43 subtracts the predicted image supplied from the intra predicting section 53 from the picture supplied from the image rearranging buffer 42.

In addition, the arithmetic section 51 adds the predicted image subtracted in the arithmetic section 43 to the data supplied from the inverse orthogonal transform section 50.

On the other hand, a non-intra picture to be subjected to inter coding is supplied from the image rearranging buffer 42 to the arithmetic section 43 and the motion predicting/motion compensating section 54.

The motion predicting/motion compensating section 54 reads the picture of a decoded image to be referred to in motion prediction for the non-intra picture from the image rearranging buffer 42 as a reference image from the frame memory 52. Further, the motion predicting/motion compensating section 54 detects a motion vector for the non-intra picture from the image rearranging buffer 42 using the reference image from the frame memory 52.

Then, the motion predicting/motion compensating section 54 generates a predicted image of the non-intra picture by applying motion compensation to the reference image according to the motion vector, and supplies the predicted image to the arithmetic sections 43 and 51. Incidentally, block size at the time of the motion compensation may be fixed or variable.

The arithmetic section 43 subtracts the predicted image supplied from the intra predicting section 53 from the non-intra picture supplied from the image rearranging buffer 42. Coding is thereafter performed as in the case of the intra picture.

Incidentally, an intra prediction mode as a mode in which the intra predicting section 53 generates a predicted image is supplied from the intra predicting section 53 to the lossless coding section 46. In addition, the motion vector obtained in the motion predicting/motion compensating section 54 and a motion compensation prediction mode as a mode in which the motion predicting/motion compensating section 54 performs motion compensation are supplied from the motion predicting/motion compensating section 54 to the lossless coding section 46.

The lossless coding section 46 performs lossless coding of information necessary for decoding, such as the intra prediction mode, the motion vector, the motion compensation prediction mode, the picture type of each picture, and the like. The lossless-coded information is included in the header of the coded data.

### [Description of Bit Stream]

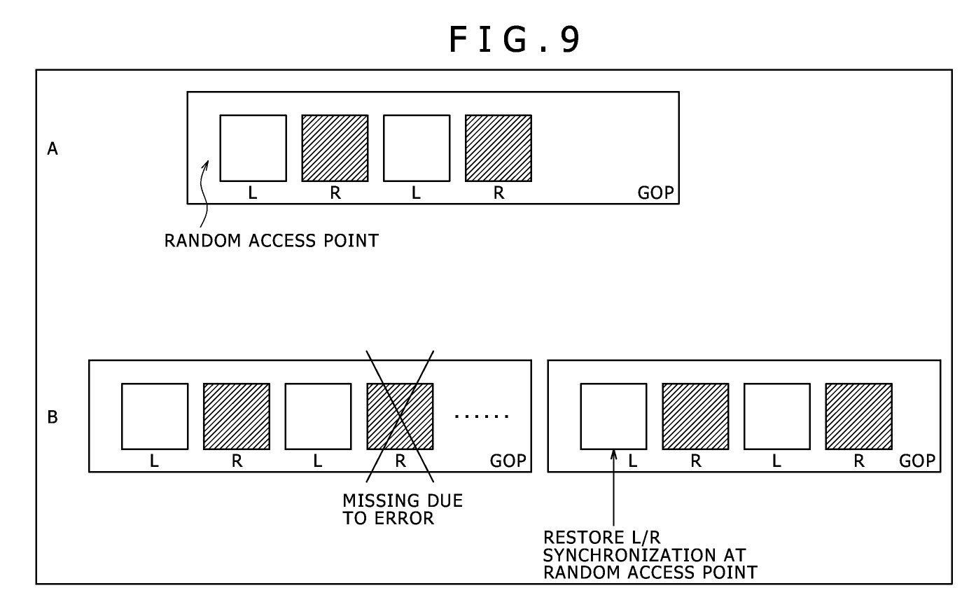

FIG. 9 is a diagram of assistance in explaining an example of the bit stream output from the coding circuit 22.

As shown in A of FIG. 9, in the bit stream output from the coding circuit 22, a random access point is the picture of image data of an L-image, and the picture of an R-image forming an LR pair with the L-image is a picture subsequent to the random access point in coding order. In addition, in the bit stream, the display order of LR pairs continues in predetermined order.

Thus, even when an error occurs in the middle of decoding the bit stream, a video decoding device for decoding the bit stream can recognize an LR pair in a decoded image by resuming decoding at an immediately subsequent random access point.

For example, as shown in B of FIG. 9, when the coded data of an R-image as a fourth image from a beginning in order of coding of the bit stream is missing due to an error, the video decoding device recognizes that the picture of a random access point immediately after a GOP including the picture of the R-image is the picture of an L-image. In addition, the picture of an R-image forming an LR pair with the L-image is present following the picture of the L-image in the coding order. Thus, when decoding is resumed from the picture of the random access point, the picture of the R-image is also decoded. Further, the display order of each LR pair continues in predetermined order.

Thus, the video decoding device can recognize the picture of a random access point and a picture continuous with the picture of the random access point in predetermined display order as an LR pair. In addition, the video decoding device can sequentially recognize each set of two decoded images subsequent to the LR pair in the display order as an LR pair. As a result, the display of a stereoscopic image can be resumed from a GOP immediately subsequent to a picture where a decoding error has occurred.

### [Example of GOP Structure of Bit Stream]

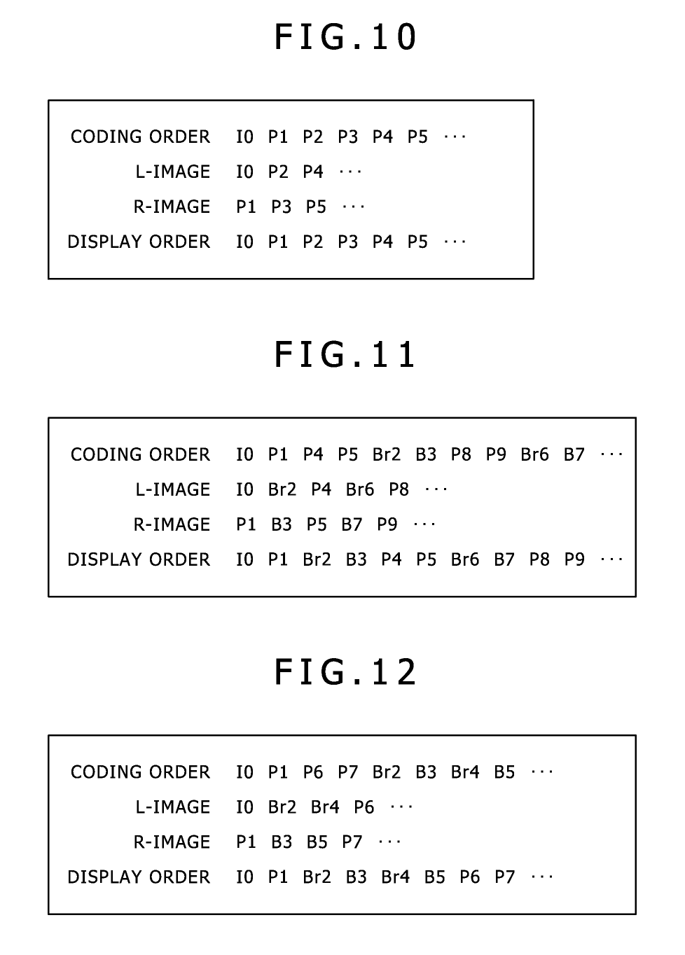

FIGS. 10 to 13 are diagrams showing examples of the GOP structure of the bit stream.

Incidentally, in FIGS. 10 to 13, I, P, B, and Br denote an I-picture, a P-picture, a B-picture, and a Br-picture, respectively, and numbers following I, P, B, and Br represent display order.

The GOP structure of FIG. 10 has the order of I0, P1, P3, P3, P4, P5, . . . as both of coding order and display order. In this case, L-images are assigned to I0, P2, P4, . . . , and R-images are assigned to P1, P3, P5, . . . . In this manner the display order of LR pairs continues in the order of an L-image and an R-image.

The GOP structure of FIG. 11 has the order of I0, P1, P4, P5, Br2, B3, P8, P9, Br6, B7, . . . as coding order, and has the order of I0, P1, Br2, B3, P4, P5, Br6, B7, P8, P9, . . . as display order. In this case, L-images are assigned to I0, Br2, P4, Br6, P8, . . . , and the image signals of R-images are assigned to P1, B3, P5, B7, P9, . . . . In this manner the display order of LR pairs continues in the order of an L-image and an R-image.

The GOP structure of FIG. 12 has the order of I0, P1, P6, P7, Br2, B3, Br4, B5, . . . as coding order, and has the order of I0, P1, Br2, B3, Br4, B5, P6, P7, . . . as display order. In this case, L-images are assigned to I0, Br2, Br4, P6, . . . , and R-images are assigned to P1, B3, B5, P7, . In this manner the display order of LR pairs continues in the order of an L-image and an R-image.

In the GOP structures of FIGS. 10 to 12, the coding order of LR pairs always continues in order of an L-image and an R-image as with the display order. As a result, on a decoding side, LR pairs are formed even when decoding is performed without B-pictures and Br-pictures, and thereby high-speed reproduction can be realized. In addition, an L-image and an R-image forming a same LR pair can be set in reference relation, so that compression efficiency is improved.

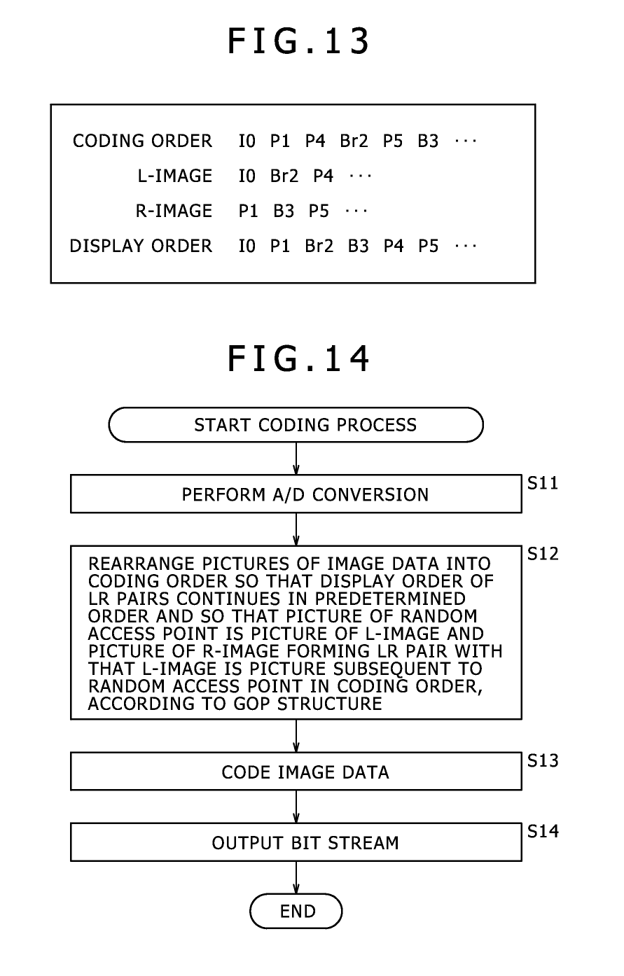

The GOP structure of FIG. 13 has the order of I0, P1, P4, Br2, P5, B3, . . . as coding order, and has the order of I0, P1, Br2, B3, P4, P5, . . . as display order. In this case, L-images are assigned to I0, Br2, P4, . . . , and R-images are assigned to P1, B3, P5, . . . . In this manner the display order of LR pairs continues in order of an L-image and an R-image.

In the GOP structure of FIG. 13, the coding order of a first LR pair continues in order of an L-image and an R-image, but the coding order of other LR pairs does not continue in order of an L-image and an R-image. However, when the bit stream having the GOP structure of FIG. 13 is decoded, a DPB (Decoded Picture Buffer) buffer for four pictures suffices.

### [Description of Processing of Coding System]

FIG. 14 is a flowchart of assistance in explaining coding processing by the coding circuit 22 of the coding system 10.

In step S11 in FIG. 14, the A/D converting section 41 (FIG. 8) in the coding circuit 22 applies A/D conversion to a multiplexed signal supplied from the video synthesizing circuit 21 to obtain image data as a digital signal. The A/D converting section 41 then supplies the image data to the image rearranging buffer 42.

In step S12, the image rearranging buffer 42 rearranges pictures of the image data into coding order so that the display order of LR pairs continues in predetermined order and so that the picture of a random access point is the picture of an L-image and the picture of an R-image forming an LR pair with the L-image is a picture subsequent to the random access point in the coding order, according to the GOP structure of the bit stream as the output of the coding circuit 22.

In step S13, the arithmetic section 43, the orthogonal transform section 44, the quantizing section 45, the lossless coding section 46, the dequantizing section 49, the inverse orthogonal transform section 50, the arithmetic section 51, the frame memory 52, the intra predicting section 53, and the motion predicting/motion compensating section 54 code the pictures of the image data supplied from the image rearranging buffer. Coded data obtained as a result of the coding is supplied to the accumulation buffer 47.

In step S14, the accumulation buffer 47 temporarily stores the coded data, and outputs the coded data as a bit stream at a predetermined rate. The process is then ended.

Incidentally, while the coding system 10 of FIG. 3 has the video synthesizing circuit 21 provided in the video coding device 13, the video synthesizing circuit 21 may be provided outside the video coding device 13. In this case, the image signal of an L-image imaged by the left eye imaging device 11 and the image signal of an R-image imaged by the right eye imaging device 12 are multiplexed in the video synthesizing circuit 21, and the multiplexed signal is input to the video coding device 13.

### [Another Example of Configuration of One Embodiment of Coding System]

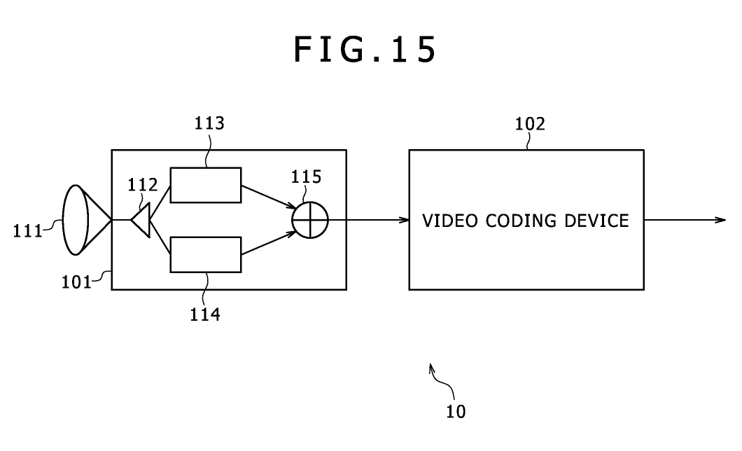

FIG. 15 is a block diagram showing another example of configuration of one embodiment of the coding system to which the present invention is applied.

The coding system 10 of FIG. 15 includes an imaging device 101 and a video coding device 102. The imaging device 101 includes an imaging section 111, a branching section 112, an imaging processing section 113 and an imaging processing section 114, and a synthesizing section 115. In the coding system 10, one imaging device 101 images an L-image and an R-image, and the image signal of the L-image and the image signal of the R-image are multiplexed and serially input to the video coding device 102.

The imaging device 101 includes the imaging section 111, the branching section 112, and the two imaging processing sections 113 and 114. The imaging section 111 performs imaging under control of the imaging processing section 113, and supplies an image signal obtained as a result of the imaging to the imaging processing section 113 via the branching section 112. In addition, the imaging section 111 performs imaging under control of the imaging processing section 114, and supplies an image signal obtained as a result of the imaging to the imaging processing section 114 via the branching section 112.

The imaging processing section 113 controls the imaging section 111 to make the imaging section 111 perform imaging in the same imaging timing as the imaging timing of the imaging processing section 114 or consecutive imaging timing different from the imaging timing of the imaging processing section 114. The imaging processing section 113 supplies an image signal supplied from the branching section 112 as a result of the imaging to the synthesizing section 115.

The imaging processing section 114 controls the imaging section 111 to make the imaging section 111 perform imaging in the same imaging timing as the imaging timing of the imaging processing section 113 or consecutive imaging timing different from the imaging timing of the imaging processing section 113. The imaging processing section 114 supplies an image signal supplied from the branching section 112 as a result of the imaging to the synthesizing section 115 as the image signal of an R-image.

The synthesizing section 115 multiplexes the image signal of the L-image supplied from the imaging processing section 113 and the image signal of the R-image supplied from the imaging processing section 114 in a temporal direction, and outputs the result to the video coding device 102.

The video coding device 102 is formed by the coding circuit 22 in FIG. 8, and codes the multiplexed signal supplied from the synthesizing section 115.

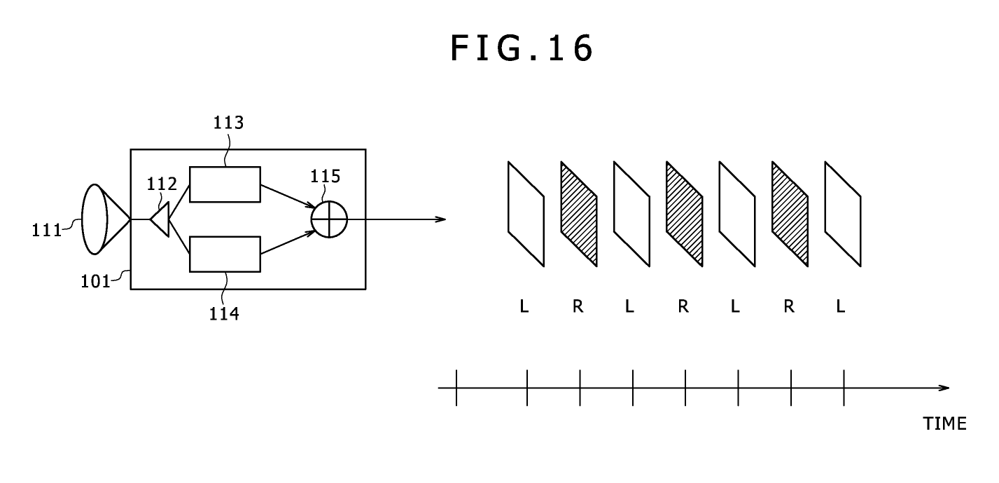

FIG. 16 is a diagram of assistance in explaining the multiplexed signal supplied from the synthesizing section 115.

As shown in FIG. 16, in the synthesizing section 115, the image signal of L-images imaged under control of the imaging processing section 113 and the image signal of R-images imaged under control of the imaging processing section 114 are multiplexed in a temporal direction. As a result, the multiplexed signal output from the synthesizing section 115 is an image signal in which the image signal of the L-images and the image signal of the R-images are alternately repeated, as shown in FIG. 16.

### [Example of Configuration of Decoding System]

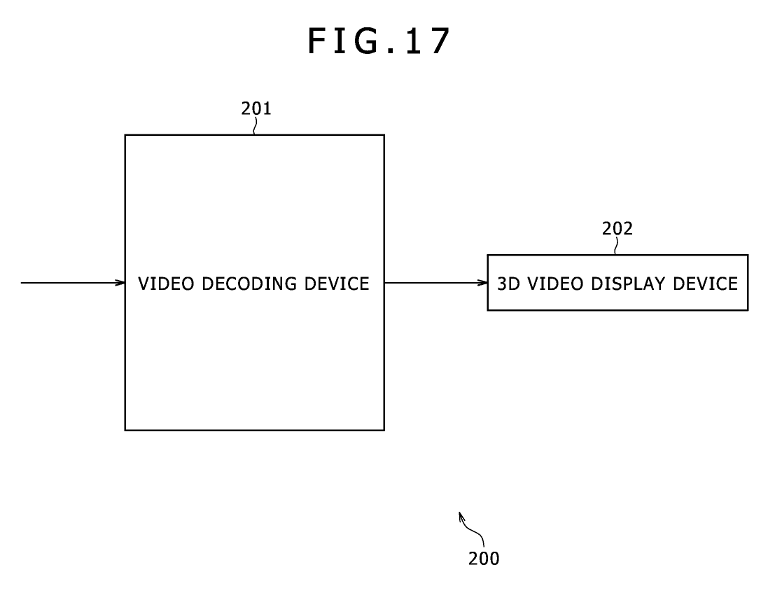

FIG. 17 is a block diagram showing an example of configuration of a decoding system for decoding the bit stream output from the above-described coding system 10.

A decoding system 200 of FIG. 17 includes a video decoding device 201 and a 3D video display device 202.

The video decoding device 201 decodes the bit stream output from the coding system 10 by a system corresponding to the AVC coding system. The video decoding device 201 outputs an image signal as an analog signal obtained as a result of the decoding to the 3D video display device 202 in each LR pair.

The 3D video display device 202 displays a 3D image on the basis of the image signal of the L-images and the image signal of the R-images input in each LR pair from the video decoding device 201. In this manner, a user can view a stereoscopic image.

Incidentally, as the 3D video display device 202, a display device displaying LR pairs in same timing can be used, or a display device displaying LR pairs in consecutive different timing can be used. Display devices displaying LR pairs in consecutive different timing include a display device that alternately interleaves L-images and R-images line by line and alternately displays the L-images and the R-images in field units, a display device that alternately displays L-images and R-images as images at a high frame rate in frame units, and the like.

### [Example of Configuration of Video Decoding Device]

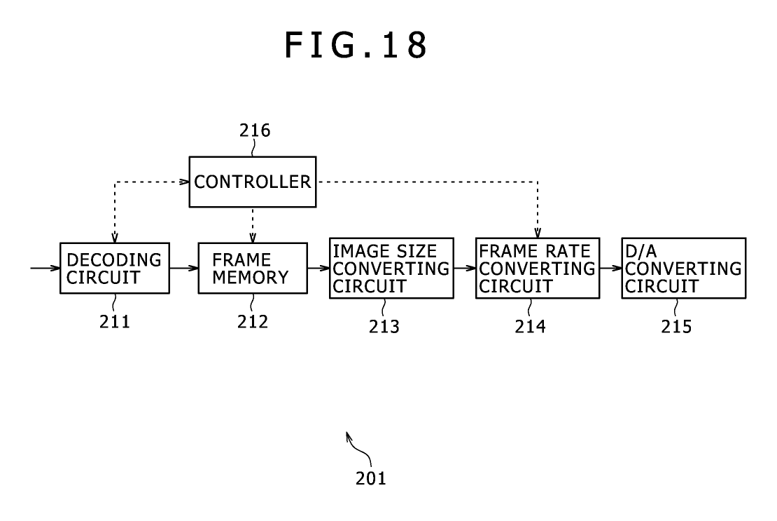

FIG. 18 is a block diagram showing an example of configuration of the video decoding device 201 in FIG. 17.

As shown in FIG. 18, the video decoding device 201 includes a decoding circuit 211, a frame memory 212, an image size converting circuit 213, a frame rate converting circuit 214, a D/A (Digital/Analog) converting circuit 215, and a controller 216.

The decoding circuit 211 decodes the bit stream output from the coding system 10 by a system corresponding to the AVC coding system according to control of the controller 216. The decoding circuit 211 supplies image data as a digital signal obtained as a result of the decoding to the frame memory 212. In addition, when an error has occurred during decoding, the decoding circuit 211 notifies the controller 216 to the effect that an error has occurred.

The frame memory 212 stores the image data supplied from the decoding circuit 211. The frame memory 212 reads the stored image data of L-images and the stored image data of R-images in units of LR pairs and outputs the image data to the image size converting circuit 213 according to control of the controller 216.

The image size converting circuit 213 enlarges or reduces each of image sizes of the image data of the LR pairs which image data is supplied from the frame memory 212 to a predetermined size, and supplies the result to the frame rate converting circuit 214.

The frame rate converting circuit 214 outputs the image data of the LR pairs supplied from the image size converting circuit 213 while controlling output timing of the image data of the LR pairs so that the frame rate of the L-images and the R-images is a predetermined rate according to control of the controller 216.

The D/A converting circuit 215 applies D/A conversion to each piece of the image data of the LR pairs output from the frame rate converting circuit 214, and outputs an image signal as an analog signal obtained as a result of the D/A conversion to the 3D video display device 202.

The controller 216 controls the decoding circuit 211 to resume decoding from a random access point in response to an error notification supplied from the decoding circuit 211. In addition, when a user gives a command to reproduce the bit stream from a predetermined position, the controller 216 controls the decoding circuit 211 to start decoding from a random access point nearest to the position.

Further, the controller 216 controls the frame memory 212 to make the frame memory 212 read the image data in each LR pair, assuming that a picture at the decoding start position or the decoding resuming position is the picture of an L-image. In addition, the controller 216 controls the frame rate converting circuit 214 to make the frame rate converting circuit 214 convert the frame rate of the image data of the L-images and the R-images output from the image size converting circuit 213 to a predetermined frame rate and then output the image data.

### [Example of Configuration of Decoding Circuit]

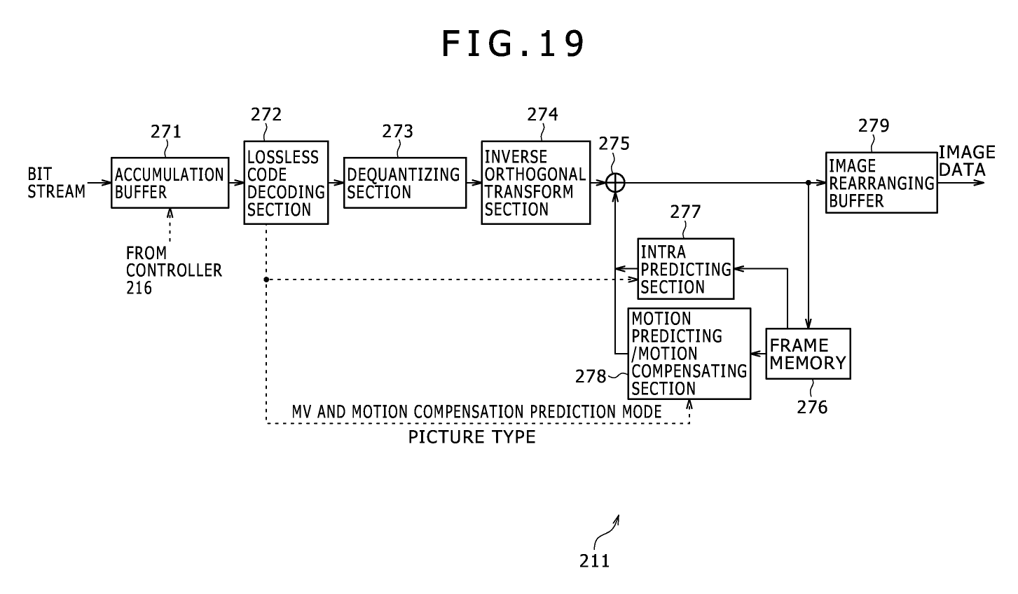

FIG. 19 is a block diagram showing an example of configuration of the decoding circuit 211 in FIG. 18.

The coded data output as a bit stream from the coding system 10 is supplied to an accumulation buffer 271. The accumulation buffer 271 temporarily stores the coded data supplied thereto. The accumulation buffer 271 reads the coded data and supplies the coded data to a lossless code decoding section 272 according to control from the controller 216. For example, according to control from the controller 216, the accumulation buffer 271 performs readout from coded data at a random access point, and supplies the coded data to the lossless code decoding section 272.

The lossless code decoding section 272 subjects the coded data from the accumulation buffer 271 to processing such as variable length decoding, arithmetic decoding, or the like on the basis of the format of the coded data. Thus, the lossless code decoding section 272 decodes quantized values and information necessary for image decoding such as the intra prediction mode, the motion vector, the motion compensation prediction mode, the picture type of each picture, and the like, which information is included in the header of the coded data.

The quantized values obtained in the lossless code decoding section 272 are supplied to a dequantizing section 273. The intra prediction mode obtained in the lossless code decoding section 272 is supplied to an intra predicting section 277. In addition, the motion vector (MV), the motion compensation prediction mode, and the picture type obtained in the lossless code decoding section 272 are supplied to a motion predicting/motion compensating section 278.

The dequantizing section 273, an inverse orthogonal transform section 274, an arithmetic section 275, a frame memory 276, the intra predicting section 277, and the motion predicting/motion compensating section 278 perform similar processing to that of the dequantizing section 49, the inverse orthogonal transform section 50, the arithmetic section 51, the frame memory 52, the intra predicting section 53, and the motion predicting/motion compensating section 54, respectively, in FIG. 8. In this manner, an image is decoded (decoded image is obtained).

Specifically, the dequantizing section 273 dequantizes the quantized values from the lossless code decoding section 272 into transform coefficients, and supplies the transform coefficients to the inverse orthogonal transform section 274.

The inverse orthogonal transform section 274 applies an inverse orthogonal transform such as an inverse discrete cosine transform, an inverse Karhunen-Loeve transform, or the like to the transform coefficients from the dequantizing section 273 on the basis of the format of the coded data, and supplies the result to the arithmetic section 275.

The arithmetic section 275 adds the pixel values of a predicted image supplied from the intra predicting section 277 to the data of an intra picture which data is included in the data supplied from the inverse orthogonal transform section 274 as required, thereby obtaining a decoded image of the intra picture. In addition, the arithmetic section 275 adds the pixel values of a predicted image supplied from the motion predicting/motion compensating section 278 to the data of a non-intra picture which data is included in the data supplied from the inverse orthogonal transform section 274, thereby obtaining a decoded image of the non-intra picture.

The decoded image obtained in the arithmetic section 275 is supplied to the frame memory 276 as required, and is supplied to an image rearranging buffer 279.

The frame memory 276 temporarily stores the decoded image supplied from the arithmetic section 275, and supplies the decoded image to the intra predicting section 277 and the motion predicting/motion compensating section 278 as a reference image used to generate a predicted image as required.

When data being processed in the arithmetic section 275 is the data of an intra picture, the intra predicting section 277 generates a predicted image of the intra picture as required using the decoded image as the reference image from the frame memory 276, and supplies the predicted image to the arithmetic section 275.

Specifically, the intra predicting section 277 generates a predicted image from pixels already stored in the frame memory 276 among pixels in the vicinity of a part (block) being processed in the arithmetic section 275 according to the intra prediction mode from the lossless code decoding section 272. The intra predicting section 277 supplies the predicted image to the arithmetic section 275.

When data being processed in the arithmetic section 275 is the data of a non-intra picture, on the other hand, the motion predicting/motion compensating section 278 generates a predicted image of the non-intra picture, and supplies the predicted image to the arithmetic section 275.

Specifically, the motion predicting/motion compensating section 278 reads the picture of the decoded image to be used to generate a predicted image as a reference image from the frame memory 276 according to the picture type and the like from the lossless code decoding section 272. Further, the motion predicting/motion compensating section 278 generates a predicted image by applying motion compensation to the reference image from the frame memory 276 according to the motion vector and the motion compensation prediction mode from the lossless code decoding section 272. The motion predicting/motion compensating section 278 supplies the predicted image to the arithmetic section 275.

The arithmetic section 275 adds the predicted image supplied from the intra predicting section 277 or the motion predicting/motion compensating section 278 as described above to the data supplied from the inverse orthogonal transform section 274, whereby a picture (pixel values of the picture) is decoded.

The image rearranging buffer 279 temporarily stores and reads out pictures (decoded images) from the arithmetic section 275, thereby changing the sequence of the pictures to an original sequence (display order). The image rearranging buffer 279 supplies the pictures in the original sequence to the frame memory 212.

Incidentally, when an error has occurred during decoding in the decoding circuit 211, a notification to an effect that the error has occurred is sent from a section that has detected the occurrence of the error to the controller 216.

### [Description of Processing of Decoding System]

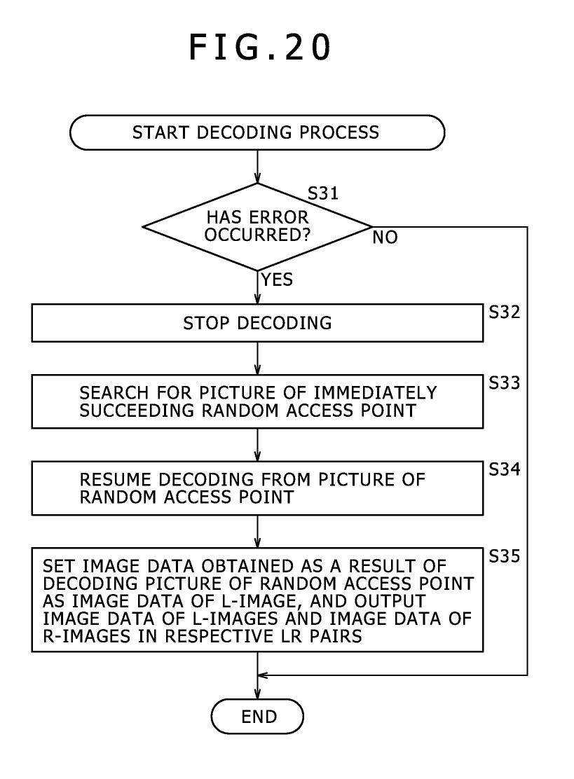

FIG. 20 is a flowchart of assistance in explaining decoding error processing by the video decoding device 201 of the decoding system 200. This decoding error processing is started when the decoding circuit 211 starts decoding, for example.

In step S31 in FIG. 20, the controller 216 determines whether an error has occurred during decoding, that is, whether a notification to an effect that an error has occurred is received from the decoding circuit 211. When determining in step S31 that an error has occurred during decoding, the controller 216 instructs the decoding circuit 211 to stop decoding. In step S32, the decoding circuit 211 stops decoding according to the instruction. Specifically, the accumulation buffer 271 (FIG. 19) in the decoding circuit 211 stops reading coded data according to the instruction from the controller 216.

In step S33, the accumulation buffer 271 in the decoding circuit 211 retrieves the coded data of the picture of a random access point immediately subsequent to a picture whose reading is stopped from stored coded data according to control of the controller 216.

In step S34, the decoding circuit 211 resumes decoding from the coded data of the picture of the random access point which coded data is retrieved in step S33. Specifically, the accumulation buffer 271 in the decoding circuit 211 starts readout from the coded data of the picture of the random access point which coded data is retrieved in step S33. Image data obtained as a result of decoding by the decoding circuit 211 is supplied to the frame memory 212 and stored in the frame memory 212.

In step S35, according to control from the controller 216, the frame memory 212 sets image data obtained as a result of decoding the picture of the random access point as image data of an L-image, and outputs the image data of L-images and the image data of R-images in respective LR pairs.

Specifically, the frame memory 212 first sets the image data of the picture of the random access point as the image data of an L-image, sets image data supplied from the decoding circuit 211 so as to be continued from the image data of the L-image in predetermined order as the image data of an R-image, and outputs the image data of the L-image and the image data of the R-image as the image data of an LR pair. The frame memory 212 then sequentially outputs the image data of two images supplied from the decoding circuit 211 after the image data of the LR pair as the image data of an LR pair. The process is then ended.

When it is determined in step S31 that no error has occurred during decoding, on the other hand, the process is ended.

Incidentally, though not shown, when a user gives a command to reproduce the bit stream from a predetermined position, the decoding system 200 retrieves the coded data of the picture of a random access point nearest to the position, and performs a process similar to that of steps S34 and S35.

As described above, the coding system 10 codes a multiplexed signal in which the image signals of LR pairs are multiplexed such that the display order of the LR pairs continues in predetermined order and such that the picture of a random access point is the picture of an L-image of an LR pair and the picture of an R-image is a picture subsequent to the picture of the random access point in coding order.

Thus, even when decoding the bit stream from the middle because of the occurrence of an error, an instruction from a user, or the like, the decoding system 200 can recognize an LR pair by performing decoding from a random access point. As a result, the decoding system 200 can display a 3D image. That is, the decoding system 200 can quickly restore the display of a 3D image when an error has occurred, or display a 3D image from a position desired by the user.

Incidentally, the above description has been made supposing that coding is performed such that the picture of a random access point is the picture of an L-image. However, coding may also be performed such that the picture of a random access point is the picture of an R-image.

[Description of Computer to which Present Invention is Applied]

Next, the series of processes described above can be carried out not only by hardware but also by software. When the series of processes is to be carried out by software, a program constituting the software is installed onto a general-purpose computer or the like.

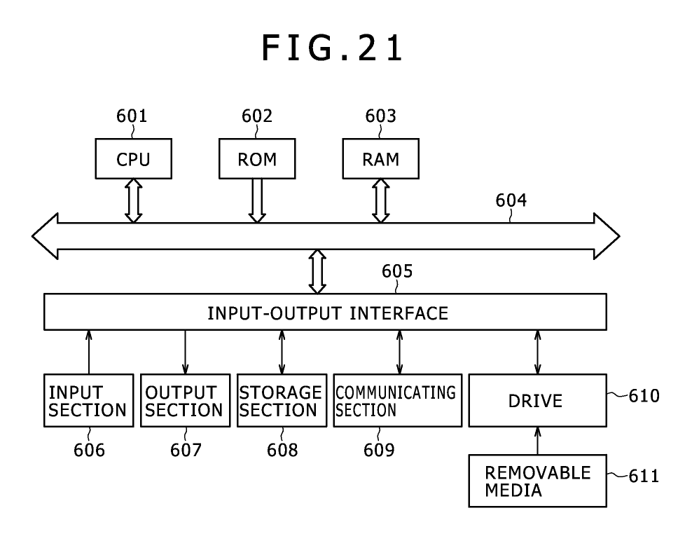

Accordingly, FIG. 21 shows an example of configuration of one embodiment of a computer onto which the program for performing the series of processes described above is installed.

The program can be recorded in advance in a storage section 608 or a ROM 602 as a recording medium included in the computer.

Alternatively, the program can be stored (recorded) on removable media 611. Such removable media 611 can be provided as so-called packaged software. In this case, the removable media 611 include for example a flexible disk, a CD-ROM (Compact Disc Read Only Memory), an MO (Magneto Optical) disk, a DVD (Digital Versatile Disc), a magnetic disk, a semiconductor memory, and the like.

Incidentally, in addition to being installed from the removable media 611 as described above onto the computer via a drive 610, the program can be downloaded to the computer via a communication network or a broadcasting network and installed into the built-in storage section 608. Specifically, the program can for example be transferred by radio from a download site to the computer via an artificial satellite for digital satellite broadcasting, or transferred by wire to the computer via networks such as a LAN (Local Area Network), the Internet, and the like.

The computer includes a CPU (Central Processing Unit) 601. The CPU 601 is connected with an input-output interface 605 via a bus 604.

When a user inputs a command to the CPU 601 via the input-output interface 605 by operating an input section 606 or the like, the CPU 601 executes the program stored in the ROM (Read Only Memory) 602 according to the command. Alternatively, the CPU 601 loads the program stored in the storage section 608 into a RAM (Random Access Memory) 603, and executes the program.

In this manner the CPU 601 performs the processing according to the above-described flowcharts or the processing performed by the configurations in the above-described block diagrams. The CPU 601 for example outputs a result of the processing from an output section 607, or transmits the result of the processing from a communicating section 609, or further records the result of the processing in the storage section 608, via the input-output interface 605 as required.

Incidentally, the recording section 606 is formed by a keyboard, a mouse, a microphone, and the like. In addition, the output section 607 is formed by an LCD (Liquid Crystal Display), a speaker, and the like.

The processing performed by the computer according to the program in the present specification does not necessarily need to be performed in time series in the order described as the flowcharts. That is, the processing performed by the computer according to the program includes processing performed in parallel or individually (for example parallel processing or processing based on an object).

In addition, the program may be processed by one computer (processor), or may be subjected to distributed processing by a plurality of computers. Further, the program may be transferred to a remote computer and executed by the remote computer.

Incidentally, in the present specification, a system refers to an apparatus as a whole formed by a plurality of devices.

It is to be noted that embodiments of the present invention are not limited to the foregoing embodiments, and that various changes can be made without departing from the spirit of the present invention.

For example, the coding system 10 and the decoding system 200 described above can be applied to arbitrary electronic devices. Examples thereof will be described in the following.

### [Example of Configuration of Television Receiver]

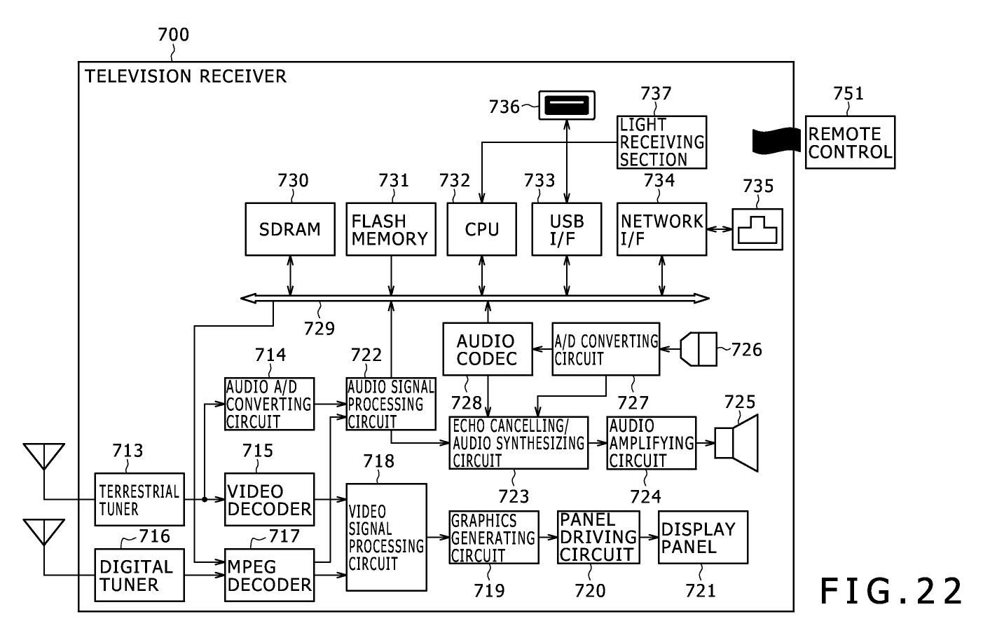

FIG. 22 is a block diagram showing an example of a main configuration of a television receiver using the decoding system to which the present invention is applied.

The television receiver 700 of FIG. 22 obtains a bit stream obtained by the coding system 10 as at least a part of a broadcast signal of digital broadcasting or content data, and displays a stereoscopic image by performing processing similar to that of the decoding system 200.

A terrestrial tuner 713 of the television receiver 700 receives a broadcast wave signal of terrestrial analog broadcasting via an antenna, demodulates the broadcast wave signal, obtains an image signal, and supplies the image signal to a video decoder 715. The video decoder 715 subjects the video signal supplied from the terrestrial tuner 713 to decoding processing, and supplies a resulting digital component signal to a video signal processing circuit 718.

The video signal processing circuit 718 subjects the video data supplied from the video decoder 715 to predetermined processing such as noise removal and the like, and supplies resulting video data to a graphics generating circuit 719.

The graphics generating circuit 719 generates video data of a program to be displayed on a display panel 721, image data resulting from processing based on an application supplied via a network, and the like, and supplies the generated video data and the generated image data to a panel driving circuit 720. In addition, as appropriate, the graphics generating circuit 719 performs a process of generating video data (graphics) for displaying a screen to be used by a user to select an item or the like and supplying the panel driving circuit 720 with video data obtained by superimposing the video data (graphics) on the video data of the program.

The panel driving circuit 720 drives the display panel 721 on the basis of the data supplied from the graphics generating circuit 719 to make the display panel 721 display the video of the program and the various screens described above.

The display panel 721 displays the video of the program and the like according to control of the panel driving circuit 720.

The television receiver 700 also includes an audio A/D (Analog/Digital) converting circuit 314, an audio signal processing circuit 722, an echo cancelling/audio synthesizing circuit 723, an audio amplifying circuit 724, and a speaker 725.

The terrestrial tuner 713 demodulates a received broadcast wave signal, thereby obtaining not only a video signal but also an audio signal. The terrestrial tuner 713 supplies the obtained audio signal to the audio A/D converting circuit 314.

The audio A/D converting circuit 314 applies A/D conversion processing to the audio signal supplied from the terrestrial tuner 713, and supplies a resulting digital audio signal to the audio signal processing circuit 722.

The audio signal processing circuit 722 subjects the audio data supplied from the audio A/D converting circuit 714 to predetermined processing such as noise removal and the like, and supplies resulting audio data to the echo cancelling/audio synthesizing circuit 723.

The echo cancelling/audio synthesizing circuit 723 supplies the audio data supplied from the audio signal processing circuit 722 to the audio amplifying circuit 724.

The audio amplifying circuit 724 subjects the audio data supplied from the echo cancelling/audio synthesizing circuit 723 to D/A conversion processing and amplification processing, adjusts the audio data to a predetermined sound volume, and thereafter outputs audio from the speaker 725.

The television receiver 700 further includes a digital tuner 716 and an MPEG decoder 717.

The digital tuner 716 receives a broadcast wave signal of digital broadcasting (terrestrial digital broadcasting, BS (Broadcasting Satellite)/CS (Communications Satellite) digital broadcasting) via an antenna, demodulates the broadcast wave signal, obtains an MPEG-TS (Moving Picture Experts Group-Transport Stream), and supplies the MPEG-TS to the MPEG decoder 717.

The MPEG decoder 717 descrambles the MPEG-TS supplied from the digital tuner 716, and extracts a stream including the data of a program as a reproduction object (viewing object). The MPEG decoder 717 decodes audio packets forming the extracted stream, and supplies resulting audio data to the audio signal processing circuit 722. The MPEG decoder 717 also decodes video packets forming the stream, and supplies resulting video data to the video signal processing circuit 718. In addition, the MPEG decoder 717 supplies EPG (Electronic Program Guide) data extracted from the MPEG-TS to a CPU 732 through a path not shown in the figure.

The video signal processing circuit 718 subjects the video data supplied from the MPEG decoder 717 to predetermined processing as in the case of the video data supplied from the video decoder 715. Video data and the like generated in the graphics generating circuit 719 is superimposed on the video data resulting from the predetermined processing as appropriate, and the video data is supplied to the display panel 721 via the panel driving circuit 720, so that the image is displayed.

The television receiver 700 performs processing similar to that of the above-described video decoding device 201 as processing for thus decoding the video packets and displaying the image on the display panel 721. As a result, LR pairs can be recognized even when the video packets are decoded from the middle.

The audio signal processing circuit 722 subjects the audio data supplied from the MPEG decoder 717 to predetermined processing as in the case of the audio data supplied from the audio A/D converting circuit 714. Then, the audio data resulting from the predetermined processing is supplied to the audio amplifying circuit 724 via the echo cancelling/audio synthesizing circuit 723 to be subjected to D/A conversion processing and amplification processing. As a result, audio adjusted to a predetermined sound volume is output from the speaker 725.

The television receiver 700 also includes a microphone 726 and an A/D converting circuit 727.

The A/D converting circuit 727 receives the signal of voice of a user which voice is captured by the microphone 726 provided to the television receiver 700 for voice conversation. The A/D converting circuit 727 applies A/D conversion processing to the received audio signal, and supplies resulting digital audio data to the echo cancelling/audio synthesizing circuit 723.

When the data of voice of the user (user A) of the television receiver 700 is supplied from the A/D converting circuit 727 to the echo cancelling/audio synthesizing circuit 723, the echo cancelling/audio synthesizing circuit 723 performs echo cancellation on the audio data of the user A. Then, after the echo cancellation, the echo cancelling/audio synthesizing circuit 723 makes the audio data resulting from being combined with other audio data, for example, output from the speaker 725 via the audio amplifying circuit 724.

The television receiver 700 further includes an audio codec 728, an internal bus 729, an SRAM (Synchronous Dynamic Random Access Memory) 730, a flash memory 731, the CPU 732, a USB (Universal Serial Bus) I/F 733, and a network I/F 734.

The A/D converting circuit 727 receives the signal of voice of the user which voice is captured by the microphone 726 provided to the television receiver 700 for voice conversation. The A/D converting circuit 727 applies A/D conversion processing to the received audio signal, and supplies resulting digital audio data to the audio codec 728.

The audio codec 728 converts the audio data supplied from the A/D converting circuit 727 into data in a predetermined format for transmission via a network, and supplies the data to the network I/F 734 via the internal bus 729.

The network I/F 734 is connected to the network via a cable inserted in a network terminal 735. The network I/F 734 for example transmits the audio data supplied from the audio codec 728 to another device connected to the network. In addition, the network I/F 734 for example receives audio data transmitted from another device connected to the network via the network terminal 735, and supplies the audio data to the audio codec 728 via the internal bus 729.

The audio codec 728 converts the audio data supplied from the network I/F 734 into data in a predetermined format, and supplies the data to the echo cancelling/audio synthesizing circuit 723.

The echo cancelling/audio synthesizing circuit 723 performs echo cancellation on the audio data supplied from the audio codec 728, and makes the audio data resulting from being combined with other audio data, for example, output from the speaker 725 via the audio amplifying circuit 724.

The SDRAM 730 stores various data necessary for the CPU 732 to perform processing.

The flash memory 731 stores a program executed by the CPU 732. The program stored in the flash memory 731 is read by the CPU 732 in predetermined timing such as at a time of starting the television receiver 700. The flash memory 731 also stores EPG data obtained via digital broadcasting, data obtained from a predetermined server via the network, and the like.

For example, the flash memory 731 stores an MPEG-TS including content data obtained from the predetermined server via the network under control of the CPU 732. The flash memory 731 supplies the MPEG-TS to the MPEG decoder 717 via the internal bus 729 under control of the CPU 732, for example.

The MPEG decoder 717 processes the MPEG-TS as in the case of the MPEG-TS supplied from the digital tuner 716. Thus, the television receiver 700 can receive content data composed of video, audio, and the like via the network, decode the content data using the MPEG decoder 717, display the video, and output the audio.

The television receiver 700 also includes a light receiving section 737 for receiving an infrared signal transmitted from a remote control 751.

The light receiving section 737 receives an infrared ray from the remote control 751, and outputs a control code indicating the content of a user operation which control code is obtained by demodulation to the CPU 732.

The CPU 732 executes the program stored in the flash memory 731, and controls the operation of the whole of the television receiver 700 according to the control code supplied from the light receiving section 737 and the like. The CPU 732 and various parts of the television receiver 700 are connected to each other via paths not shown in the figure.

The USB I/F 733 transmits and receives data to and from a device external to the television receiver 700, which device is connected via a USB cable inserted in a USB terminal 736. The network I/F 734 is connected to the network via a cable inserted in the network terminal 735, and also transmits and receives data other than audio data to and from various devices connected to the network.

### [Description of Configuration of Portable Telephone]

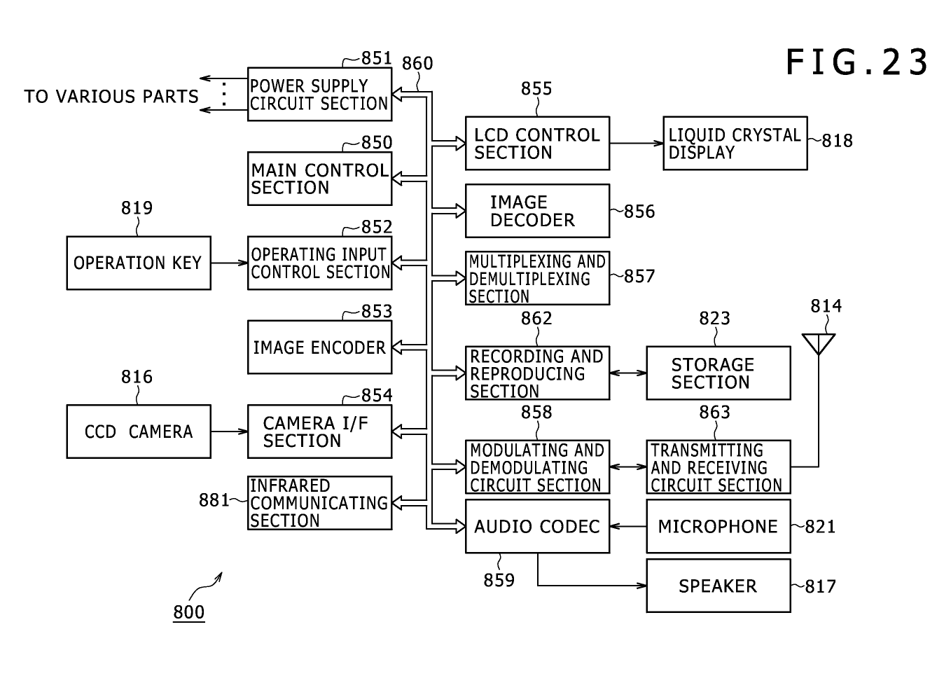

FIG. 23 is a block diagram showing an example of a main configuration of a portable telephone using the coding system and the decoding system to which the present invention is applied.

A portable telephone 800 of FIG. 23 performs processing similar to that of the above-described coding system 10, and obtains a bit stream for displaying a stereoscopic image. In addition, the portable telephone 800 receives a bit stream obtained in the above-described coding system 10, performs processing similar to that of the decoding system 200, and displays a stereoscopic image.

The portable telephone 800 of FIG. 23 includes a main control section 850 designed to control various parts in a centralized manner, a power supply circuit section 851, an operating input control section 852, an image encoder 853, a camera I/F section 854, an LCD control section 855, an image decoder 856, a multiplexing and demultiplexing section 857, a recording and reproducing section 862, a modulating and demodulating circuit section 858, and an audio codec 859. These parts are connected to each other via a bus 860.

The portable telephone 800 also includes an operating key 819, a CCD (Charge Coupled Device) camera 816, a liquid crystal display 818, a storage section 823, a transmitting and receiving circuit section 863, an antenna 814, a microphone (mike) 821, and a speaker 817.

The power supply circuit section 851 activates the portable telephone 800 into an operable state by supplying power from a battery pack to various parts when a call ending and power supply key is set in an on state by an operation of a user.

The portable telephone 800 performs various kinds of operation such as the transmission and reception of audio signals, the transmission and reception of electronic mail and image data, picture taking, data recording, and the like in various kinds of modes such as a voice call mode, a data communication mode, and the like on the basis of control of the main control section 850, which includes a CPU, a ROM, a RAM, and the like.

For example, in the voice call mode, the portable telephone 800 converts an audio signal obtained by collecting sound by the microphone (mike) 821 into digital audio data by the audio codec 859, subjects the audio data to spectrum spreading processing in the modulating and demodulating circuit section 858, and subjects the audio data to digital-to-analog conversion processing and frequency conversion processing in the transmitting and receiving circuit section 863. The portable telephone 800 transmits a signal for transmission which signal is obtained by the conversion processing to a base station not shown in the figure via the antenna 814. The signal for transmission (audio signal) transmitted to the base station is supplied to a portable telephone at the other end of the call via a public telephone network.

In addition, for example, in the voice call mode, the portable telephone 800 amplifies a received signal received by the antenna 814 in the transmitting and receiving circuit section 863, further subjects the received signal to frequency conversion processing and analog-to-digital conversion processing, subjects the received signal to spectrum despreading processing in the modulating and demodulating circuit section 858, and converts the received signal into an analog audio signal by the audio codec 859. The portable telephone 800 outputs the analog audio signal obtained by the conversion from the speaker 817.

Further, for example, when electronic mail is to be transmitted in the data communication mode, the portable telephone 800 receives, in the operating input control section 852, text data for the electronic mail which text data is input by operating the operating key 819. The portable telephone 800 processes the text data in the main control section 850, and displays the text data as an image on the liquid crystal display 818 via the LCD control section 855.

In addition, the portable telephone 800 generates electronic mail data in the main control section 850 on the basis of the text data received by the operating input control section 852, a user instruction, and the like. The portable telephone 800 subjects the electronic mail data to spectrum spreading processing in the modulating and demodulating circuit section 858, and subjects the electronic mail data to digital-to-analog processing and frequency conversion processing in the transmitting and receiving circuit section 863. The portable telephone 800 transmits a signal for transmission which signal is obtained by the conversion processing to a base station not shown in the figure via the antenna 814. The signal for transmission (electronic mail) transmitted to the base station is supplied to a predetermined address via a network and a mail server or the like.

In addition, for example, when electronic mail is received in the data communication mode, the portable telephone 800 receives a signal transmitted from a base station in the transmitting and receiving circuit section 863 via the antenna 814, amplifies the signal, and further subjects the signal to frequency conversion processing and analog-to-digital conversion processing. The portable telephone 800 reconstructs original electronic mail data by subjecting the received signal to spectrum despreading processing in the modulating and demodulating circuit section 858. The portable telephone 800 displays the reconstructed electronic mail data on the liquid crystal display 818 via the LCD control section 855.

Incidentally, the portable telephone 800 can also record (store) the received electronic mail data in the storage section 823 via the recording and reproducing section 862.

This storage section 823 is an arbitrary rewritable storage medium. The storage section 823 may be for example a semiconductor memory such as a RAM, a built-in flash memory, or the like, may be a hard disk, or may be a removable medium such as a magnetic disk, a magneto-optical disk, an optical disk, a USB memory, a memory card, or the like. It is needless to say that the storage section 823 may be other than these media.

Further, for example, when image data is to be transmitted in the data communication mode, the portable telephone 800 generates image data by imaging with the CCD camera 816. The CCD camera 816 includes a lens, an optical device such as a diaphragm or the like, and a CCD as a photoelectric conversion element. The CCD camera 816 images a subject, converts the intensity of received light into an electric signal, and generates the image data of an image of the subject. The image encoder 853 converts the image data into coded image data by compression-coding the image data via the camera I/F section 854 by a predetermined coding system such as MVC or AVC, for example.

The portable telephone 800 performs processing similar to that of the above-described video coding device 13 (102) as processing for thus compression-coding the image data generated by imaging. As a result, LR pairs can be recognized even when the coded image data is decoded from the middle.

The portable telephone 800 multiplexes the coded image data supplied from the image encoder 853 and the digital audio data supplied from the audio codec 859 by a predetermined system in the multiplexing and demultiplexing section 857. The portable telephone 800 subjects multiplexed data obtained as a result of the multiplexing to spectrum spreading processing in the modulating and demodulating circuit section 858, and subjects the multiplexed data to digital-to-analog conversion processing and frequency conversion processing in the transmitting and receiving circuit section 863. The portable telephone 800 transmits a signal for transmission which signal is obtained by the conversion processing to a base station not shown in the figure via the antenna 814. The signal for transmission (image data) transmitted to the base station is supplied to the other end of communication via a network and the like.

Incidentally, when image data is not to be transmitted, the portable telephone 800 can display the image data generated by the CCD camera 816 and the like on the liquid crystal display 818 via the LCD control section 855 without the intervention of the image encoder 853.

In addition, for example, when the data of a moving image file linked to a simplified home page or the like is received in the data communication mode, the portable telephone 800 receives a signal transmitted from a base station in the transmitting and receiving circuit section 863 via the antenna 814, amplifies the signal, and further subjects the signal to frequency conversion processing and analog-to-digital conversion processing. The portable telephone 800 reconstructs original multiplexed data by subjecting the received signal to spectrum despreading processing in the modulating and demodulating circuit section 858. The portable telephone 800 separates the multiplexed data into coded image data and audio data in the multiplexing and demultiplexing section 857.

The portable telephone 800 generates reproduced moving image data by decoding the coded image data by a decoding system corresponding to a predetermined coding system such as MVC, AVC, or the like in the image decoder 856. The portable telephone 800 displays the reproduced moving image data on the liquid crystal display 818 via the LCD control section 855. In this manner for example, moving image data included in the moving image file linked to the simplified home page is displayed on the liquid crystal display 818.

The portable telephone 800 performs processing similar to that of the above-described video decoding device 201 as processing for thus decoding the coded image data and displaying the image data on the liquid crystal display 818. As a result, LR pairs can be recognized even when the moving image file is decoded from the middle.

Incidentally, as in the case of electronic mail, the portable telephone 800 can record (store) the received data linked to the simplified home page and the like in the storage section 823 via the recording and reproducing section 862.

In addition, the portable telephone 800 can analyze a two-dimensional code obtained by imaging with the CCD camera 816 in the main control section 850, and obtain information recorded in the two-dimensional code.

Further, the portable telephone 800 can communicate with an external device via infrared rays by an infrared communicating section 881.

Incidentally, while the portable telephone 800 uses the CCD camera 816 in the above description, an image sensor (CMOS image sensor) using CMOS (Complementary Metal Oxide Semiconductor) may be used in place of the CCD camera 816. Also in this case, the portable telephone 800 can image a subject and generate the image data of an image of the subject as in the case of using the CCD camera 816.

In addition, while the above description has been made of the portable telephone 800, the coding system and the decoding system described above can be applied to any device such as a PDA (Personal Digital Assistants), a smart phone, a UMPC (Ultra Mobile Personal Computer), a netbook, a notebook personal computer, or the like as in the case of the portable telephone 800 as long as the device has an imaging function and a communicating function similar to those of the portable telephone 800.

### [Example of Configuration of Hard Disk Recorder]

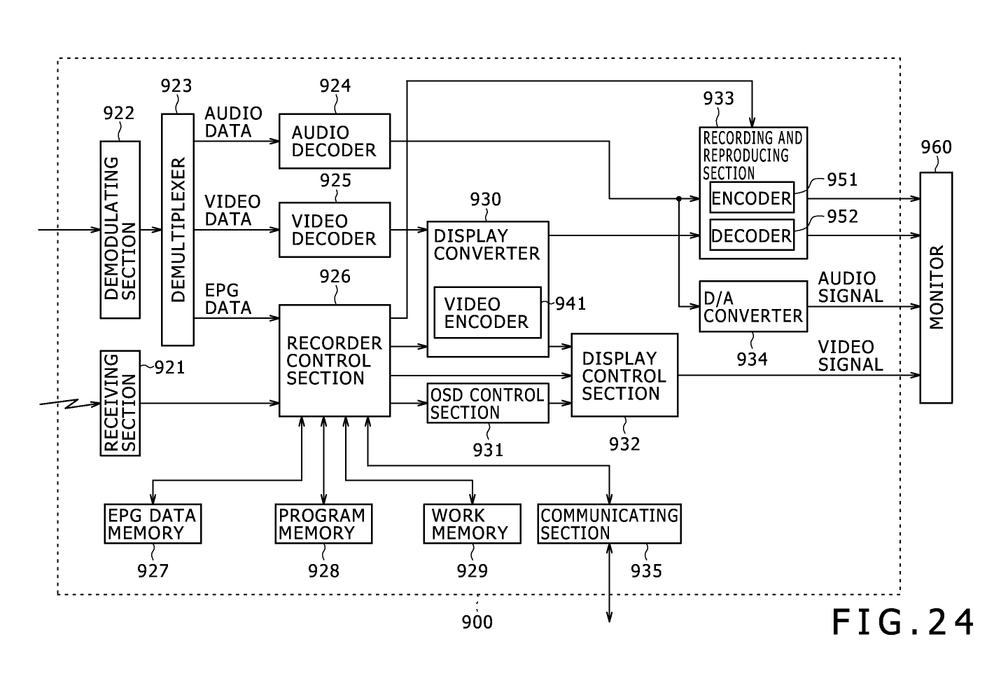

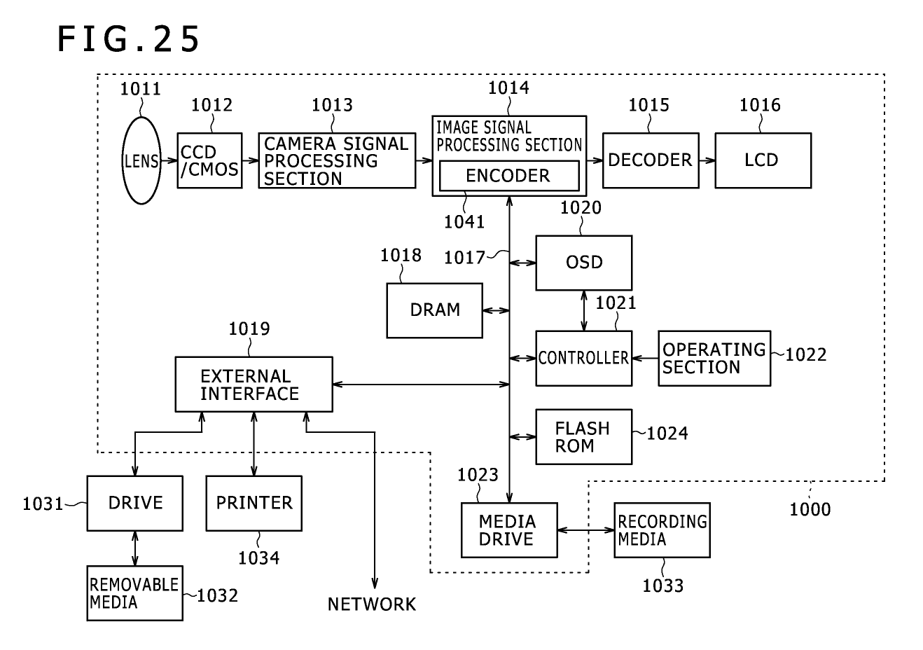

FIG. 24 is a block diagram showing an example of a main configuration of a hard disk recorder and a monitor using the decoding system to which the present invention is applied.

The hard disk recorder (HDD recorder) 900 of FIG. 24 obtains a bit stream obtained in the above-described coding system 10 as a part of a broadcast wave signal (television signal) or the like transmitted by a satellite, an antenna on the ground, or the like, which broadcast wave signal is received by a tuner, and stores the bit stream in a built-in hard disk. Then, in timing corresponding to a user instruction, the hard disk recorder 900 performs similar processing to that of the decoding system 200 using the stored bit stream to display a stereoscopic image on a monitor 960.

The hard disk recorder 900 includes a receiving section 921, a demodulating section 922, a demultiplexer 923, an audio decoder 924, a video decoder 925, and a recorder control section 926. The hard disk recorder 900 further includes an EPG data memory 927, a program memory 928, a work memory 929, a display converter 930, an OSD (On Screen Display) control section 931, a display control section 932, a recording and reproducing section 933, a D/A converter 934, and a communicating section 935.

In addition, the display converter 930 includes a video encoder 941. The recording and reproducing section 933 includes an encoder 951 and a decoder 952.

The receiving section 921 receives an infrared signal from a remote control (not shown), converts the infrared signal into an electric signal, and outputs the electric signal to the recorder control section 926. The recorder control section 926 is formed by a microprocessor, for example. The recorder control section 926 performs various kinds of processing according to a program stored in the program memory 928. At this time, the recorder control section 926 uses the work memory 929 as required.

The communicating section 935 is connected to a network. The communicating section 935 performs communication processing with another device via the network. For example, the communicating section 935 is controlled by the recorder control section 926 to communicate with a tuner (not shown) and output a channel selecting control signal principally to the tuner.

The demodulating section 922 demodulates a signal supplied from the tuner, and outputs the signal to the demultiplexer 923. The demultiplexer 923 separates the data supplied from the demodulating section 922 into audio data, video data, and EPG data. The demultiplexer 923 outputs the audio data, the video data, and the EPG data to the audio decoder 924, the video decoder 925, or the recorder control section 926, respectively.

The audio decoder 924 decodes the input audio data by an MPEG system, for example, and outputs the decoded audio data to the recording and reproducing section 933. The video decoder 925 decodes the input video data by the MPEG system, for example, and outputs the decoded video data to the display converter 930. The recorder control section 926 supplies the input EPG data to the EPG data memory 927 to store the EPG data in the EPG data memory 927.

The display converter 930 encodes the video data supplied from the video decoder 925 or the recorder control section 926 into video data of an NTSC (National Television Standards Committee) system by the video encoder 941. The display converter 930 outputs the video data to the recording and reproducing section 933.

The hard disk recorder 900 performs processing similar to that of the above-described video coding device 13 (102) as processing for thus encoding the video data. As a result, LR pairs can be recognized even when the encoded video data is decoded from the middle.

In addition, the display converter 930 converts the size of a screen of the video data supplied from the video decoder 925 or the recorder control section 926 into a size corresponding to the size of the monitor 960. The display converter 930 further converts the video data with the converted screen size into video data of the NTSC system by the video encoder 941, converts the video data into an analog signal, and outputs the analog signal to the display control section 932.

Under control of the recorder control section 926, the display control section 932 superimposes an OSD signal output by the OSD (On Screen Display) control section 931 on the video signal input from the display converter 930, and outputs a resulting signal to the display of the monitor 960 to make the monitor 960 display the signal.

The hard disk recorder 900 performs similar processing to that of the above-described video decoding device 201 as processing for thus decoding the video data and displaying an image on the monitor 960. As a result, LR pairs can be recognized even when the video data is decoded from the middle.

The monitor 960 is also supplied with the audio data output by the audio decoder 924 after being converted into an analog signal by the D/A converter 934. The monitor 960 outputs the audio signal from a built-in speaker.

The recording and reproducing section 933 has a hard disk as a storage medium for recording the video data, the audio data, and the like.

The recording and reproducing section 933 for example encodes the audio data supplied from the audio decoder 924 by the MPEG system by the encoder 951. In addition, the recording and reproducing section 933 encodes the video data supplied from the video encoder 941 in the display converter 930 by the MPEG system by the encoder 951. The recording and reproducing section 933 synthesizes the coded data of the audio data and the coded data of the video data with each other by a multiplexer. The recording and reproducing section 933 subjects the synthesized data to channel coding and amplification, and writes the data to the hard disk via a recording head.

The recording and reproducing section 933 reproduces data recorded on the hard disk via a reproducing head, amplifies the data, and separates the data into audio data and video data by a demultiplexer. The recording and reproducing section 933 decodes the audio data and the video data by the MPEG system by the decoder 952. The recording and reproducing section 933 subjects the decoded audio data to D/A conversion, and outputs the result to the speaker of the monitor 960. The recording and reproducing section 933 subjects the decoded video data to D/A conversion, and outputs the result to the display of the monitor 960.

The recorder control section 926 reads latest EPG data from the EPG data memory 927 on the basis of a user instruction indicated by an infrared signal from the remote control which infrared signal is received via the receiving section 921. The recorder control section 926 supplies the EPG data to the OSD control section 931. The OSD control section 931 generates image data corresponding to the input EPG data, and outputs the image data to the display control section 932. The display control section 932 outputs the video data input from the OSD control section 931 to the display of the monitor 960 to make the monitor 960 display the video data. An EPG (Electronic Program Guide) is thereby displayed on the display of the monitor 960.

In addition, the hard disk recorder 900 can obtain various kinds of data such as video data, audio data, EPG data, or the like supplied from other devices via networks such as the Internet and the like.

The communicating section 935 is controlled by the recorder control section 926 to obtain coded data of video data, audio data, EPG data, and the like transmitted from other devices via the networks and supply the coded data to the recorder control section 926. The recorder control section 926 for example supplies the obtained coded data of the video data and the audio data to the recording and reproducing section 933 to make the coded data stored on the hard disk. At this time, the recorder control section 926 and the recording and reproducing section 933 may perform processing such as re-encoding or the like as required.

In addition, the recorder control section 926 decodes the obtained coded data of the video data and the audio data, and supplies resulting video data to the display converter 930. As with the video data supplied from the video decoder 925, the display converter 930 processes the video data supplied from the recorder control section 926, and supplies the video data to the monitor 960 via the display control section 932 to make the monitor 960 display the image.

In addition, in synchronism with the image display, the recorder control section 926 may supply the decoded audio data to the monitor 960 via the D/A converter 934 to make the audio output from the speaker.

Further, the recorder control section 926 decodes the obtained coded data of the EPG data, and supplies the decoded EPG data to the EPG data memory 927.

Incidentally, while the above description has been made of the hard disk recorder 900 that records video data and audio data on the hard disk, the recording medium may be any recording medium, of course. For example, as in the case of the above-described hard disk recorder 900, the coding system and the decoding system described above can be applied to a recorder to which a recording medium other than the hard disk, such for example as a flash memory, an optical disk, or a video tape is applied.

### [Example of Configuration of Camera]

FIG. 25 is a block diagram showing an example of a main configuration of a camera using the coding system and the decoding system to which the present invention is applied.

The camera 1000 of FIG. 25 performs similar processing to that of the coding system 10, and obtains a bit stream. In addition, the camera 1000 performs similar processing to that of the decoding system 200, and displays a stereoscopic image using the bit stream.

A lens block 1011 of the camera 1000 makes light (that is, an image of a subject) incident on a CCD/CMOS 1012. The CCD/CMOS 1012 is an image sensor using a CCD or CMOS. The CCD/CMOS 1012 converts the intensity of the received light into an electric signal, and supplies the electric signal to a camera signal processing section 1013.

The camera signal processing section 1013 converts the electric signal supplied from the CCD/CMOS 1012 into Y, Cr, and Cb, Cr and Cb being color-difference signals. The camera signal processing section 1013 supplies the image signals to an image signal processing section 1014. Under control of a controller 1021, the image signal processing section 1014 subjects the image signals supplied from the camera signal processing section 1013 to predetermined image processing, and codes the image signals by a system such for example as AVC or MVC in an encoder 1041.

The camera 1000 performs similar processing to that of the above-described video coding device 13 (102) as processing for thus coding the image signal generated by imaging. As a result, LR pairs can be recognized even when the coded image signal is decoded from the middle.

The image signal processing section 1014 supplies the coded data generated by coding the image signal to a decoder 1015. Further, the image signal processing section 1014 obtains data for display which data is generated in an on-screen display (OSD) 1020, and supplies the data for display to the decoder 1015.

In the above processing, the camera signal processing section 1013 uses a DRAM (Dynamic Random Access Memory) 1018 connected via a bus 1017 as appropriate to make the DRAM 1018 retain the image data, the coded data obtained by coding the image data, and the like as required.

The decoder 1015 decodes the coded data supplied from the image signal processing section 1014, and supplies resulting image data (decoded image data) to an LCD 1016. In addition, the decoder 1015 supplies the data for display which data is supplied from the image signal processing section 1014 to the LCD 1016. The LCD 1016 synthesizes an image of the decoded image data and an image of the data for display, the decoded image data and the data for display being supplied from the decoder 1015, as appropriate, and displays the synthesized image.

The camera 1000 performs similar processing to that of the above-described video decoding device 201 as processing for thus decoding the coded data and displaying the decoded data on the LCD 1016. As a result, LR pairs can be recognized even when the coded data is decoded from the middle.

The on-screen display 1020 outputs the data for display of menu screens, icons, and the like composed of symbols, characters, or graphics to the image signal processing section 1014 via the bus 1017 under control of the controller 1021.

The controller 1021 performs various kinds of processing on the basis of signals indicating contents for which commands are given by a user using an operating section 1022, and controls the image signal processing section 1014, the DRAM 1018, an external interface 1019, the on-screen display 1020, a media drive 1023, and the like via the bus 1017. A FLASH ROM 1024 stores programs, data, and the like necessary for the controller 1021 to perform the various kinds of processing.

For example, the controller 1021 can code the image data stored in the DRAM 1018 and decode the coded data stored in the DRAM 1018 in place of the image signal processing section 1014 and the decoder 1015. At this time, the controller 1021 may perform the coding and decoding processing by similar systems to the coding and decoding systems of the image signal processing section 1014 and the decoder 1015, or may perform the coding and decoding processing by systems not supported by the image signal processing section 1014 or the decoder 1015.

In addition, for example, when an instruction to start printing an image is given from the operating section 1022, the controller 1021 reads the image data from the DRAM 1018, and supplies the image data to a printer 1034 connected to the external interface 1019 via the bus 1017 to make the printer 1034 print the image data.

Further, for example, when an instruction to record an image is given from the operating section 1022, the controller 1021 reads the coded data from the DRAM 1018, and supplies the coded data to a recording media 1033 loaded in the media drive 1023 via the bus 1017 to make the recording media 1033 store the coded data.

The recording media 1033 are for example arbitrary readable and writable removable media such as magnetic disks, magneto-optical disks, optical disks, semiconductor memories, or the like. The recording media 1033 are arbitrary kinds of removable media, of course, and may be tape devices, may be disks, or may be memory cards. The recording media 1033 may of course be noncontact IC cards or the like.

In addition, the media drive 1023 and the recording media 1033 may be integrated with each other, and formed by a nonportable storage medium such for example as a built-in hard disk drive, an SSD (Solid State Drive), or the like.

The external interface 1019 is for example formed by a USB input-output terminal or the like, and connected to the printer 1034 when an image is printed. In addition, the external interface 1019 is connected with a drive 1031 as required, into which drive removable media 1032 such as magnetic disks, optical disks, magneto-optical disks, or the like are loaded as appropriate. Computer programs read from these removable media are installed into the FLASH ROM 1024 as required.

The external interface 1019 further includes a network interface connected to a predetermined network such as a LAN, the Internet, or the like. The controller 1021 can read coded data from the DRAM 1018, and supply the coded data to another device connected via the network from the external interface 1019 according to an instruction from the operating section 1022, for example. In addition, the controller 1021 can obtain coded data and image data supplied from another device via the network via the external interface 1019, and make the DRAM 618 retain the coded data and the image data and supply the coded data and the image data to the image signal processing section 1014.

Incidentally, the image data obtained by imaging by the camera 1000 may be moving images, or may be still images.

Of course, the coding system 10 and the decoding system 200 described above are also applicable to devices and systems other than the devices described above.

### DESCRIPTION OF REFERENCE NUMERALS

10: Coding system, 22: Coding circuit

1. An image processing device comprising:
coding means for coding images of multiple visual points, the images of the multiple visual points forming a stereoscopic image; and
controlling means for controlling said coding means so as to perform arrangement and coding such that a first picture in a random access unit is a picture of one image of the images of said multiple visual points and a picture of a remaining image is a picture subsequent to said first picture in coding order.

2. The image processing device according to claim 1,
wherein said controlling means controls said coding means so as to perform arrangement and coding such that the pictures of the images of the multiple visual points including the image as said first picture are consecutive in the coding order.

3. The image processing device according to claim 1,
wherein said controlling means controls said coding means so as to perform arrangement and coding such that the pictures of the images of the multiple visual points are always consecutive in the coding order.

4. The image processing device according to claim 1,
wherein the images of said multiple visual points are stereo images composed of a left image observed by a left eye and a right image observed by a right eye, and
said controlling means controls said coding means so as to perform arrangement and coding such that the first picture in said random access unit is a picture of said left image and a picture of the right image forming the stereo images with the left image is subsequent to said first picture in the coding order.

5. The image processing device according to claim 1,
wherein the images of said multiple visual points are stereo images composed of a left image observed by a left eye and a right image observed by a right eye, and
said controlling means controls said coding means so as to perform arrangement and coding such that the first picture in said random access unit is a picture of said right image and a picture of the left image forming the stereo images with the right image is subsequent to said first picture in the coding order.

6. An image processing method comprising:
a coding step of an image processing device coding images of multiple visual points, the images of the multiple visual points forming a stereoscopic image; and
a controlling step of the image processing device controlling said coding so as to perform arrangement and coding such that a first picture in a random access unit is a picture of one image of the images of said multiple visual points and a picture of a remaining image is a picture subsequent to said first picture in coding order.

7. An image processing device comprising:
decoding means for decoding a coded stream obtained by performing arrangement and coding such that a first picture in a random access unit of images of multiple visual points, the images of the multiple visual points forming a stereoscopic image, is a picture of one image of the images of said multiple visual points and a picture of a remaining image is a picture subsequent to said first picture in coding order; and
controlling means for controlling said decoding means so as to start decoding from the first picture in said random access unit when said decoding means decodes said coded stream from a middle.

8. The image processing device according to claim 7,
wherein when an error has occurred during said decoding, said controlling means controls said decoding means so as to stop the decoding by said decoding means and start decoding from a first picture of a said random access unit immediately after a picture whose decoding is stopped.

9. The image processing device according to claim 7,
wherein when a command to perform decoding from a predetermined position of said coded stream is given, said controlling means controls said decoding means so as to start decoding from a first picture of a said random access unit nearest to the position.

10. The image processing device according to claim 7,
wherein the images of said multiple visual points are stereo images composed of a left image observed by a left eye and a right image observed by a right eye,
said coded stream is obtained by performing arrangement and coding such that the first picture in said random access unit is a picture of said left image and a picture of the right image forming the stereo images with the left image is subsequent to said first picture in the coding order, and
said decoding means outputs image data obtained by decoding the first picture in said random access unit as image data of said left image.

11. The image processing device according to claim 7,
wherein the images of said multiple visual points are stereo images composed of a left image observed by a left eye and a right image observed by a right eye,
said coded stream is obtained by performing arrangement and coding such that the first picture in said random access unit is a picture of said right image and a picture of the left image forming the stereo images with the right image is subsequent to said first picture in the coding order, and
said decoding means outputs image data obtained by decoding the first picture in said random access unit as image data of said right image.

12. An image processing method comprising:
a decoding step of an image processing device decoding a coded stream obtained by performing arrangement and coding such that a first picture in a random access unit of images of multiple visual points, the images of the multiple visual points forming a stereoscopic image, is a picture of one image of the images of said multiple visual points and a picture of a remaining image is a picture subsequent to said first picture in coding order; and
a controlling means step of the image processing device controlling said decoding so as to start decoding from the first picture in said random access unit when a process of said decoding step decodes said coded stream from a middle.
